(19) United States
(12) Patent Application Publication
(10) Pub. No.: US 2025/0226896 A1
(43) Pub. Date: Jul. 10, 2025

(54) MEASUREMENT REPORTS FOR RADIO FREQUENCY SENSING AND CELLULAR POSITIONING

(71) Applicant: QUALCOMM Incorporated, San Diego, CA (US)

(72) Inventors: Weimin DUAN, San Diego, CA (US); Alexandros MANOLAKOS, Athens (GR); Hyojin LEE, San Diego, CA (US)

(21) Appl. No.: 18/839,681

(22) PCT Filed: Mar. 22, 2023
(86) PCT No.: PCT/US2023/015975

§ 371 Date: Aug. 19, 2024

(30) Foreign Application Priority Data
Apr. 26, 2022 (GR) 20220100344

(51) Int. Cl. H04B 17/27; G01S 7/00; G01S 13/86; H04B 17/318; H04L 5/00; H04W 24/10; H04W 64/00

(52) U.S. Cl. CPC H04B 17/27; G01S 7/006; G01S 13/86; H04B 17/328; H04L 5/0048; H04W 24/10; H04W 64/00

(57) ABSTRACT

A device is configured to perform positioning sessions and radio frequency (RF) sensing sessions in a cellular network. The positioning sessions may be previously defined positioning sessions, in which a device uses reference signals (RSs) to generate positioning measurements. RF sensing sessions may be defined sessions using the existing infrastructure for positioning sessions in order to generate RF sensing measurements. With the device to report both the positioning measurements and the RF sensing measurements, the device may adjust a previously defined measurement report for positioning measurements to also include RF sensing measurements, or the device may generate newly defined measurement reports to include the RF sensing measurements. The device may also prioritize reporting the positioning measurements and the RF sensing measurements, which may be based on a latency requirement of the different measurements, a quality of the measurements, or a use case of the device.

### CROSS-REFERENCE TO RELATED APPLICATION

This application claims the benefit of Greece Patent Application Serial No. 20220100344, entitled “MEASUREMENT REPORTS FOR RADIO FREQUENCY SENSING AND CELLULAR POSITIONING” and filed on Apr. 26, 2022, which is expressly incorporated by reference herein in its entirety.

### BACKGROUND

### Field

Subject matter disclosed herein relates to the combination of radio frequency sensing and cellular based positioning and more particularly to the measurement reports generated for when both radio frequency sensing and cellular based positioning occur.

### Information

The location of a user equipment (UE), such as a cellular telephone, may be useful or essential to a number of applications including emergency calls, navigation, direction finding, asset tracking and Internet service. The location of a UE may be estimated based on information gathered from various systems. In a cellular network implemented according to 4G (also referred to as Fourth Generation) Long Term Evolution (LTE) radio access or 5G (also referred to as Fifth Generation) “New Radio” (NR), for example, a base station may transmit downlink reference signals or a UE may transmit uplink reference signals that are used for positioning.

Radio frequency (RF) sensing may also be useful or essential to a number of applications, such as detecting nearby objects for obstacle avoidance, mapping nearby surroundings, and so on.

### SUMMARY

A device (such as a base station (BS) or a user equipment (UE)) performing positioning sessions for a UE in a cellular network is to generate positioning measurements (such as an angle of arrival (AoA), a transmit-receive transmission time difference, and so on) based on reference signals between the UE and another device (such as a positioning reference signal (PRS) from a base station to the UE or a sounding reference signal (SRS) from the UE to the base station). The device performing radio frequency (RF) sensing is to also generate RF sensing measurements (such as a doppler measurement, a range (which may be based on a transmit-receive transmission time difference), an angle of the RF signal, and so on) for any objects in the environment of the device. Both the positioning measurements and the RF sensing measurements may be included in one or more defined measurement reports. The measurement reports may include a positioning measurement report already defined for the positioning measurements and a new RF sensing measurement report that is defined for the RF sensing measurements. Alternatively, a previously defined positioning measurement report may be adjusted to include one or more RF sensing measurements.

In addition, there may be limited bandwidth to report the positioning measurements and the RF sensing measurements. A device to report the positioning measurements and the RF sensing measurements is configured to prioritize the measurements for reporting. Prioritizing measurements may include prioritizing RF sensing measurement reports with reference to positioning measurements reports or may include prioritizing the RF sensing measurements themselves with reference to the positioning measurements (which may be included in the same measurement report or different measurement reports). The prioritization may be predefined, based on a quality of the measurements, based on a latency requirements for the different measurements, or based on specific use cases of the device.

In one implementation, a method for performing radio frequency (RF) sensing in a cellular network is described. The method includes receiving one or more reference signals (RSs), where receiving one or more RSs includes receiving an RS on one or more paths associated with the device. The method also includes calculating one or more positioning measurements from the one or more RSs and calculating one or more RF sensing measurements from the one or more RSs. The method further includes generating one or more measurement reports, where the one or more measurement reports include at least a portion of the one or more positioning measurements and the one or more RF sensing measurements. The method also includes providing at least a portion of the one or more measurement reports to another device in the cellular network, where measurements included in the one or more measurement reports are to be used for positioning of a user equipment (UE) in the cellular network and for RF sensing associated with the device. The one or more measurement reports may include combined measurement reports including both RF sensing measurements and positioning measurements or may include separate measurement reports for the RF sensing measurements and for the positioning measurements.

In one implementation, a device configured for performing RF sensing in a cellular network is described. The device includes a wireless transceiver, a memory, and at least one processor coupled to the wireless transceiver and memory. The at least one processor is configured to receive, via the wireless transceiver, one or more reference signals (RSs), where receiving one or more RSs includes receiving an RS on one or more paths associated with the device. The at least one processor is also configured to calculate one or more positioning measurements from the one or more RSs and calculate one or more RF sensing measurements from the one or more RSs. The at least one processor is further configured to generate one or more measurement reports, where the one or more measurement reports include at least a portion of the one or more positioning measurements and the one or more RF sensing measurements. The at least one processor is also configured to provide at least a portion of the one or more measurement reports to another device in the cellular network, where measurements included in the one or more measurement reports are to be used for positioning of a UE in the cellular network and for RF sensing associated with the device. The one or more measurement reports may include combined measurement reports including both RF sensing measurements and positioning measurements or may include separate measurement reports for the RF sensing measurements and for the positioning measurements.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system.

FIG. 2 illustrates a block diagram of a design of a base station (BS) and user equipment (UE), which may be one of the base stations and one of the UEs in FIG. 1.

FIG. 3 illustrates a UE capable of performing radio frequency (RF) sensing and positioning in a wireless network.

FIG. 4 illustrates a base station capable of performing RF sensing and positioning in a wireless network.

FIG. 5 illustrates a server capable of supporting RF sensing and positioning of a UE in a wireless network.

FIG. 6 illustrates a timing diagram depicting an example signaling flow for a positioning session in a 5G new radio (NR) network.

FIG. 7 illustrates a timing diagram depicting an example signaling flow for an RF sensing session in a 5G NR network.

FIG. 8 shows a flowchart for an exemplary method for performing RF sensing and positioning sessions in a wireless network.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” (BS) are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the IEEE 802.11 set of standards, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNodeB or gNB), etc. In addition, in some systems a base station may provide purely edge node signaling functions while in other systems it may provide additional control and/or network management functions. A communication link through which UEs can send signals to a base station is called an uplink (UL) or reverse link channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). A communication link through which UEs can send signals to or from each other is called a sidelink (SL). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station).

A wireless network (and the components therein, such as one or more UEs, one or more base stations, and one or more core network components) may be configured to support both positioning sessions and RF sensing. For example, a UE performing a positioning session may be configured to calculate positioning measurements from one or more reference signals (such as from a positioning reference signal (PRS) on a downlink (DL) from a base station). Additionally or alternatively, a base station performing a positioning session may be configured to calculate positioning measurements from one or more reference signals (such as from a sounding reference signal (SRS) on an uplink (UL) from a UE). A device calculating one or more positioning measurements may also perform RF sensing to detect one or more objects in range of the device (such as people, cars, trees, other devices, or any other objects that may reflect a RS). As described herein, RF sensing may be performed by leveraging existing infrastructure used for positioning sessions in the wireless network.

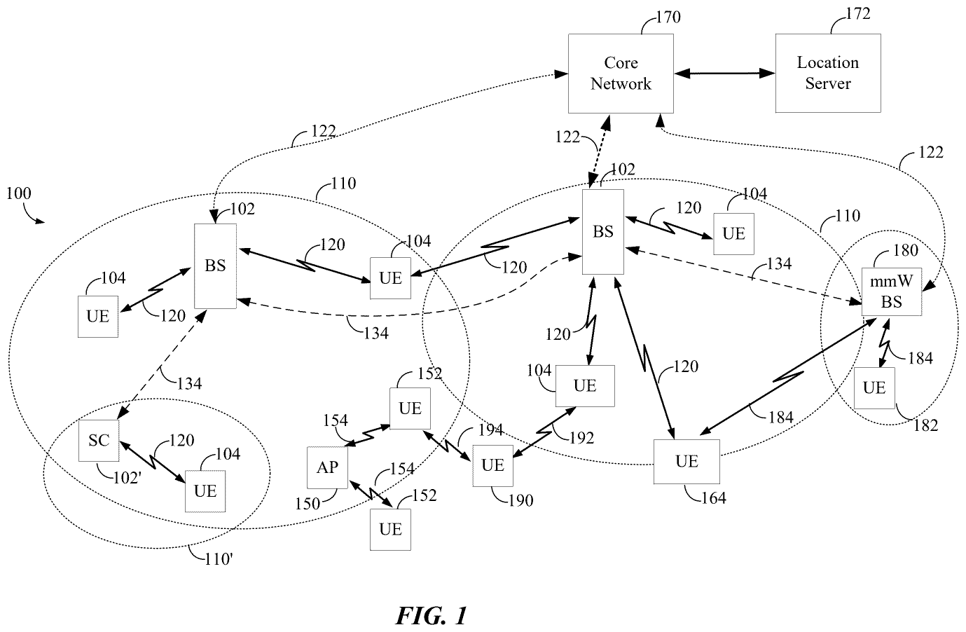

FIG. 1 illustrates an exemplary wireless communications system 100. The wireless communications system 100 (which may also be referred to as a wireless wide area network (WWAN) or a wireless network (e.g., a cellular network)) may include various base stations 102 and various UEs 104, which one or more of the base stations 102 and/or UEs 104 may sometimes be referred to herein as TRPs 102 or 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to a location server 172, which may include one or more location servers implementing a location management function (LMF). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. In some implementations, one or more base stations 102 may also be configured for RF sensing. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station or UE (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or DL (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more sidelinks (SLs), such as device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), BLUETOOTH® (Bluetooth), and so on. In the example, the UE 190 may be a relay UE between the UE 152 and a base station 102. One or multiple UEs may be relay UEs between a device and a base station.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

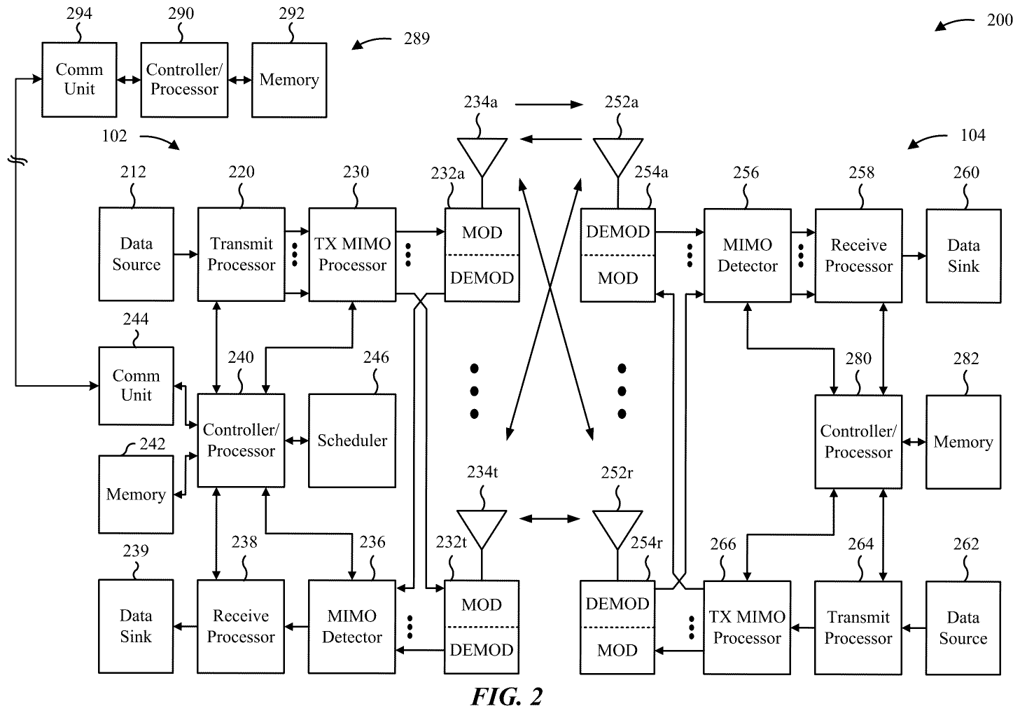

A target UE 104 for positioning may be within wireless range of one or more base stations 102 (which may be TRPs 102 for positioning of the target UE 104). For UE positioning, a base station may transmit a PRS on a DL to one or more target UEs, or a target UE may transmit an SRS on an UL to one or more base stations. In addition to a PRS or SRS, one or more other reference signals (RSs) may be transmitted between the devices. In some aspects, the receiving device measures one or more positioning measurements (such as an angle of arrival (AoA), a round trip time (RTT), a transmit-receive (tx-rx) time difference, etc.) from the SRS or PRS (or other RS), with the positioning measurements to be provided to a location server for calculating a location of the UE in the wireless network. In addition to performing UE positioning sessions, a UE or base station may also perform RF sensing sessions. An example UE or base station to perform the described operations with reference to RF sensing and UE positioning are depicted in FIGS. 2-4.

FIG. 2 shows a block diagram of a design 200 of base station 102 and UE 104, which may be one of the base stations and one of the UEs in FIG. 1. Base station 102 may be equipped with T antennas 234a through 234t, and UE 104 may be equipped with R antennas 252a through 252r, where in general T≥1 and R≥1. In some implementations, T antennas 234a through 234t or R antennas 252a through 252r may be part of an antenna array (which may be configured to operate as a phased array). For example, each antenna 234a through 234t may represent a subarray of an antenna array, with the subarray including a plurality of antennas. For implementation considerations, an antenna array may have multiple antennas that are configured together (with the multiple antennas making up a subarray). As such, the power and frequency used to control the antennas of the subarray is the same, allowing fewer oscillators and power supplies to be required than if each antenna is independently configured in the antenna array. In another example, each antenna 234a through 234t or antenna 252a through 252r may be a single antenna.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS) or PRS). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, T antennas 234a through 234t may also receive one or more SRSs from UE 104 or transmit one or more PRSs to UE 104.

At UE 104, antennas 252a through 252r may receive the downlink signals from base station 102 and/or other base stations and may provide received signals to demodulators (DEMODs) 254a through 254r, respectively. Each demodulator 254 may condition (e.g., filter, amplify, down convert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor (such as the receive processor 258 or the controller/processor 280) may determine reference signal received power (RSRP), received signal strength indicator (RSSI), reference signal received quality (RSRQ), channel quality indicator (CQI), and/or the like. In some implementations, the controller/processor 280 may measure one or more positioning measurements and/or one or more RF sensing measurements from a PRS (and/or other RSs, such as an SRS for RF sensing) received by antennas 252a through 252r. In some aspects, one or more components of UE 104 may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (such as an SRS). The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 102. At base station 102, the uplink signals from UE 104 and other UEs may be received by antennas 234, processed by demodulators, detected by a MIMO detector 236 if applicable, and further processed by a receive processor 238 to obtain decoded data and control information sent by UE 104. Receive processor 238 may provide the decoded data to a data sink 239 and the decoded control information to controller/processor 240. In some implementations, the controller/processor 240 may measure one or more positioning measurements and/or one or more RF sensing measurements from an SRS (and/or other RSs, such as a PRS for RF sensing) received by antennas 234a through 234t. Base station 102 may include communication unit 244 and communicate to network controller 289 via communication unit 244. Network controller 289 may include communication unit 294, controller/processor 290, and memory 292. The network controller 289 may be location server 172, which may be coupled to the base station 102 via core network 170.

Controller/processor 240 of base station 102, controller/processor 280 of UE 104, controller 290 of network controller 289, which may be location server 172, and/or any other component(s) of FIG. 2 may perform one or more techniques associated with supporting positioning services for a UE, as described in more detail elsewhere herein. The controller/processor 240 of base station 102, controller/processor 280 of UE 104, controller 290 of network controller 289, which may be location server 172, and/or any other component(s) of FIG. 2 may also perform one or more techniques associated with supporting RF sensing services for a device (which may be a UE or a base station). UE positioning and RF sensing may be performed within a short amount of time of each other such that positioning measurements and RF sensing measurements may be reported to a base station or to a location server in a wireless network. For example, controller/processor 240 of base station 102, controller 290 of network controller 289, controller/processor 280 of UE 104, and/or any other component(s) of FIG. 2 may perform or direct operations of, for example, the processes depicted in the Figures and as described herein. Memories 242, 282, and 292 may store data and program codes for base station 102, UE 104, and network controller 289, respectively. In some aspects, memory 242 and/or memory 282 and/or memory 292 may comprise a non-transitory computer-readable medium storing one or more instructions for wireless communication. For example, the one or more instructions, when executed by one or more processors of base station 102, network controller 289, and/or the UE 104 may perform or direct operations of the processes described herein. A scheduler 246 may schedule UEs for data transmission on the downlink and/or uplink.

The location server 172 (which may include the network controller 289) may be configured to determine a configuration of one or more reference signals for UE positioning, to determine a position of one or more UEs in the wireless network, to store positioning information for the one or more UEs, or to perform other operations associated with positioning of one or more UEs in the wireless network. The positioning information may be used for various operations, such as cell selection, handover, navigation, beamforming, or other aspects of a wireless network 100. The location server 172 (and/or a base station) may also be configured to process RF sensing measurements for one or more sensing devices. The RF sensing information may be used for various operations, such as mapping an environment of each device, calculate navigation of the device for obstacle avoidance, etc.

As indicated above, FIG. 2 is provided as an example. Other examples may differ from what is described with regard to FIG. 2. For example, while FIG. 2 depicts communication between a base station 102 and a UE 104, communications may occur between multiple base stations 102 and/or multiple UEs 104 for positioning sessions and/or RF sensing sessions.

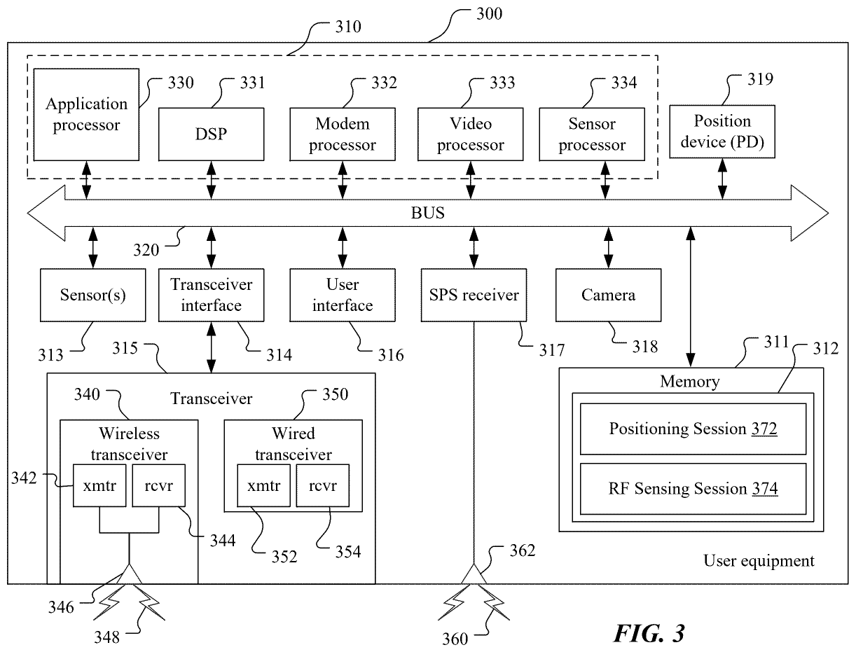

FIG. 3 illustrates a UE 300, which is an example of the UE 104, capable of performing positioning services of the UE 300 and RF sensing services in a wireless network (such as the wireless network 100). The UE 300 may include a computing platform including one or more of at least one processor 310, memory 311 including software (SW) 312, one or more sensors 313, a transceiver interface 314 for a transceiver 315, a user interface 316, a Satellite Positioning System (SPS) receiver 317, a camera 318, or a position device (PD) 319. The processor 310, the memory 311, the sensor(s) 313, the transceiver interface 314, the user interface 316, the SPS receiver 317, the camera 318, and/or the position device 319 may be communicatively coupled to each other by a bus 320 (which may be configured, e.g., for optical and/or electrical communication). One or more of the shown apparatus (e.g., the camera 318, the SPS receiver 317, and/or one or more of the sensor(s) 313, etc.) may be omitted from the UE 300. The processor 310 may include one or more intelligent hardware devices, e.g., a central processing unit (CPU), a microcontroller, an application specific integrated circuit (ASIC), etc. The processor 310 may comprise multiple processors including an application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random access memory (RAM), flash memory, disc memory, and/or read-only memory (ROM), etc. The memory 311 stores the software 312 which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311.

The configuration of the UE 300 shown in FIG. 3 is an example and not limiting of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more antennas 346.

The UE 300 may comprise the modem processor 332 that may be capable of performing baseband processing of signals received and down-converted by the transceiver 315 and/or the SPS receiver 317. The modem processor 332 may perform baseband processing of signals to be upconverted for transmission by the transceiver 315. Also or alternatively, baseband processing may be performed by the processor 330 and/or the DSP 331. Other configurations, however, may be used to perform baseband processing.

The UE 300 may include the sensor(s) 313 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 300 in three dimensions) and/or one or more gyroscopes capable of detecting motion including rotation of the UE 300. The sensor(s) 313 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the processor 330 in support of one or more applications such as, for example, applications directed to positioning and/or navigation operations. The sensor(s) 313 may be used in relative positioning measurements, relative positioning determination, motion determination, etc. Information detected by the sensor(s) 313 may be used for motion detection, relative displacement, dead reckoning, sensor-based positioning determination, and/or sensor-assisted positioning determination.

The transceiver 315 may include one or both of a wireless transceiver 340 or a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348. In some implementations, the wireless signals 348 may be transduced to wired (e.g., electrical and/or optical) signals and from wired (e.g., electrical and/or optical) signals, and the wired signals may be transduced to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with one or more base stations, one or more UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. If the UE 300 is to include a wired transceiver, the wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315.

The antennas 346 may include an antenna array. The antenna array may be capable of transmit beamforming or receive beamforming, e.g., by increasing the gain setting and/or adjust the phase setting of an array of antennas in a particular direction to amplify (e.g., to increase the gain level of) the RF signals received from that direction. The antennas 346 may further include a plurality of antenna panels, wherein each antenna panel is capable of beamforming. The antennas 346 are capable of adaptation, e.g., selection of one or more antennas for controlling receiving transmitted beams from a base station. A reduced number of beams or a single beam, for example, may be selected for reception of a wide angle beam, e.g., to reduce power consumption, while an increased number of antennas in an antenna array may be selected when the transmit beam is relatively narrow. Instead of controlling each antenna of the antenna array individually, the antenna array may include a plurality of subarrays, with each subarray capable of being controlled independently. Alternatively, the antennas 346 may include a plurality of independently controlled antennas.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

The SPS receiver 317 (e.g., a Global Positioning System (GPS) receiver or other Global Navigation Satellite System (GNSS) receiver) may be capable of receiving and acquiring SPS signals 360 via an SPS antenna 362. The antenna 362 is configured to transduce the wireless signals 360 to wired signals, e.g., electrical or optical signals, and may be integrated with the antenna 346. The SPS receiver 317 may be configured to process, in whole or in part, the acquired SPS signals 360 for estimating a location of the UE 300. For example, the SPS receiver 317 may be configured to determine location of the UE 300 by trilateration/multilateration using the SPS signals 360. The processor 330, the memory 311, the DSP 331, the PD 319 and/or one or more additional specialized processors (not shown) may be utilized to process acquired SPS signals, in whole or in part, and/or to calculate an estimated location of the UE 300, in conjunction with the SPS receiver 317. The memory 311 may store indications (e.g., measurements) of the SPS signals 360 and/or other signals (e.g., signals acquired from the wireless transceiver 340) for use in performing positioning operations. The general-purpose processor 330, the DSP 331, the PD 319, and/or one or more additional specialized processors, and/or the memory 311 may provide or support a location engine for use in processing measurements to estimate a location of the UE 300. In some implementations, the estimated locations of the UE may be used for calibration of a positioning session, such as by determining angle errors associated with different locations of a UE with reference to a known location of a base station as described above.

The UE 300 may include the camera 318 for capturing still or moving imagery. The camera 318 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The position device (PD) 319 may be configured to determine a position of the UE 300, motion of the UE 300, and/or relative position of the UE 300, and/or time. For example, the PD 319 may communicate with, and/or include some or all of, the SPS receiver 317 and the wireless transceiver 340. The PD 319 may work in conjunction with the processor 310 and the memory 311 as appropriate to perform at least a portion of one or more positioning methods, although the description herein may refer only to the PD 319 of the processor 310 being configured to perform, or performing, in accordance with the positioning method(s). The PD 319 may also or alternatively be configured to determine a location of the UE 300 using terrestrial-based signals (e.g., at least some of the signals 348) for trilateration/multilateration, for assistance with obtaining and using the SPS signals 360, or both. The PD 319 may be configured to use one or more other techniques (e.g., relying on the UE's self-reported location (e.g., part of the UE's position beacon)) for determining the location of the UE 300, and may use a combination of techniques (e.g., SPS and terrestrial positioning signals) to determine the location of the UE 300. The PD 319 may include one or more of the sensors 313 (e.g., gyroscope(s), accelerometer(s), magnetometer(s), etc.) that may sense orientation and/or motion of the UE 300 and provide indications thereof that the processor 310 (e.g., the processor 330 and/or the DSP 331) may be configured to use to determine motion (e.g., a velocity vector and/or an acceleration vector) of the UE 300. The PD 319 may be configured receive angle measurements and provide an angle error based on the determined position. The PD 319 may be used for calibration of a positioning session, such as described above with the generation of angle measurements or angle errors for known UE locations.

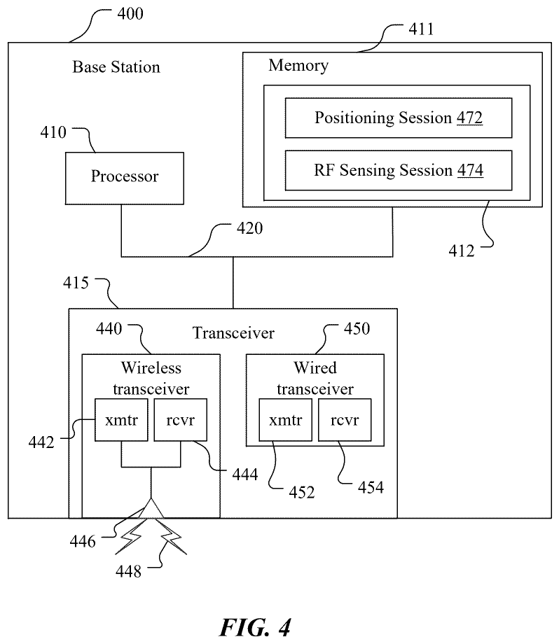

The configuration of the UE 300 shown in FIG. 3 is an example and not limiting of the disclosure, including the claims, and other configurations may be used. For example, the description herein discusses that the UE 300 is configured to perform or performs several functions, but one or more of these functions may be performed by the location server 172 and/or the base station 400 (depicted in FIG. 4).

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include a positioning session module 372 that when implemented by the one or more processors 310 configures the one or more processors 310 to engage in a positioning session to be used for generating one or more positioning measurements, as described herein. The one or more processors 310 may also engage in generating and providing one or more reports to report the one or more positioning measurements. The memory 311 may also include an RF sensing module 374 that when implemented by the one or more processors 310 configures the one or more processors 310 to engage in an RF sensing session to be used for generating one or more RF sensing measurements associated with neighboring objects, as described herein. In implementing the RF sensing session module 374 in conjunction with implementing the positioning session module 372, the one or more processors 310 may also engage in generating and providing one or more reports to report the one or more RF sensing measurements. While the positioning session module 372 and the RF sensing session module 374 are depicted as being software included in memory 311, the positioning session module 372 and the RF sensing session module 374 may be a hardware module, a software module, or a combination of hardware and software. For example, one or both modules may include one or more application specific integrated circuits (ASICs), executable code, or a combination of both.

FIG. 4 illustrates a base station 400, which is an example of the base station 102, capable of performing positioning services for a UE and RF sensing services in a wireless network (such as wireless network 100). The base station 400 may include a computing platform including one or more of at least one processor 410, a memory 411 including software (SW) 412, or a transceiver 415. The processor 410, the memory 411, and the transceiver 415 may be communicatively coupled to each other by a bus 420 (which may be configured, e.g., for optical and/or electrical communication). One or more of the shown apparatus may be omitted from the base station 400, or the base station 400 may include one or more apparatus not shown. The processor 410 may include one or more intelligent hardware devices, e.g., a central processing unit (CPU), a microcontroller, an application specific integrated circuit (ASIC), etc. The processor 410 may comprise multiple processors (e.g., including one or more of an application processor, a DSP, a modem processor, a video processor, and/or a sensor processor, similar to that shown in FIG. 3). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to operate as a special purpose computer programmed to perform the various functions described herein. Alternatively, the software 412 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the base station 400 performing a function as shorthand for one or more appropriate components of the base station 400 performing the function. The processor 410 may include a memory with stored instructions in addition to and/or instead of the memory 411.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting and/or receiving (e.g., on one or more uplink channels and/or one or more downlink channels) wireless signals 448 and transducing signals from the wireless signals 448 to wired (e.g., electrical and/or optical) signals and from wired (e.g., electrical and/or optical) signals to the wireless signals 448. The antenna 446 is one or more antenna arrays capable of beam forming and transmitting and receiving beams, including beams used in transmitting or receiving signals (including PRSs) for positioning services. Also or alternatively, signals may be transmitted omnidirectionally. The transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., to send communications to, and receive communications from, the location server 172. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The antennas 446 may include one or more antenna arrays. An antenna array may be capable of transmit beamforming or receive beamforming, e.g., by increasing the gain setting and/or adjust the phase setting of an array of antennas in a particular direction to amplify (e.g., to increase the gain level of) the RF signals received from that direction. The antennas 446 may further include a plurality of antenna panels, wherein each antenna panel is capable of beamforming. The antennas 446 are capable of adaptation, e.g., selection of one or more antennas for controlling receiving transmitted beams from a UE. A reduced number of beams or a single beam, for example, may be selected for reception of a wide angle beam, e.g., to reduce power consumption, while an increased number of antennas in an antenna array may be selected when the transmit beam is relatively narrow. In another example, different antennas may be selected for reception of a reference signal from different angles relative to the base station 400. Instead of controlling each antenna of the antenna array individually, an antenna array may include a plurality of subarrays, with each subarray capable of being controlled independently. Alternatively, the antennas 446 may include a plurality of independently controlled antennas.

The configuration of the base station 400 shown in FIG. 4 is an example and not limiting of the disclosure, including the claims, and other configurations may be used. For example, the description herein discusses that the base station 400 is configured to perform or performs several functions, but one or more of these functions may be performed by the location server 172 and/or the UE 300.

The memory 411 may store software 412 that contains executable program code or software instructions that when executed by the processor 410 may cause the processor 410 to operate as a special purpose computer programmed to perform the functions disclosed herein. As illustrated, the memory 411 may include one or more components or modules that may be implemented by the processor 410 to perform the disclosed functions. While the components or modules are illustrated as software 412 in memory 411 that is executable by the processor 410, it should be understood that the components or modules may be stored in another computer readable medium or may be dedicated hardware either in the processor 410 or off the processor. A number of software modules and data tables may reside in the memory 411 and be utilized by the processor 410 in order to manage both communications and the functionality described herein. It should be appreciated that the organization of the contents of the memory 411 as shown is merely exemplary, and as such the functionality of the modules and/or data structures may be combined, separated, and/or be structured in different ways depending upon the implementation.

The memory 411, for example, may include a positioning session module 472 that when implemented by the one or more processors 410 configures the one or more processors 410 to engage in a positioning session to be used for generating one or more positioning measurements, as described herein. The one or more processors 410 may also engage in generating and providing one or more reports to report the one or more positioning measurements. The memory 411 may also include an RF sensing module 474 that when implemented by the one or more processors 410 configures the one or more processors 410 to engage in an RF sensing session to be used for generating one or more RF sensing measurements associated with neighboring objects, as described herein. In implementing the RF sensing session module 474 in conjunction with implementing the positioning session module 472, the one or more processors 410 may also engage in generating and providing one or more reports to report the one or more RF sensing measurements. While the positioning session module 472 and the RF sensing session module 474 are depicted as being software included in memory 411, the positioning session module 472 and the RF sensing session module 474 may be a hardware module, a software module, or a combination of hardware and software. For example, one or both modules may include one or more application specific integrated circuits (ASICs), executable code, or a combination of both.

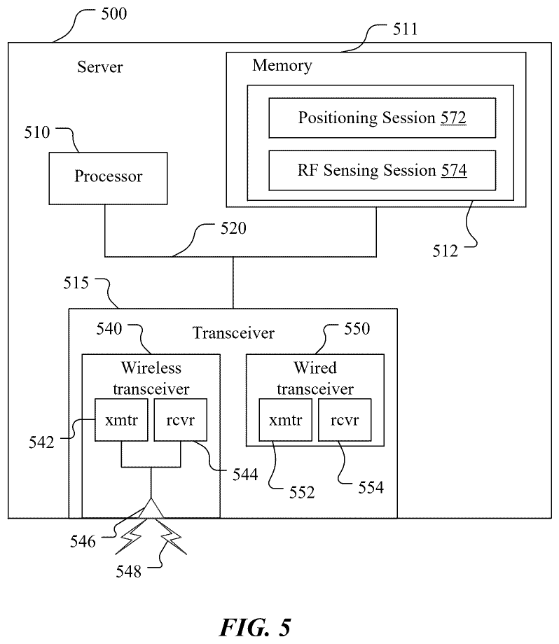

FIG. 5 shows a server 500, which is an example of the location server 172 capable of supporting positioning services for one or more UEs and/or supporting RF sensing services for one or more devices in a wireless network (such as wireless network 100). The server 500 includes a computing platform including one or more of at least one processor 510, memory 511 including software (SW) 512, or a transceiver 515. The processor 510, the memory 511, and the transceiver 515 may be communicatively coupled to each other by a bus 520 (which may be configured, e.g., for optical and/or electrical communication). One or more of the shown apparatus (e.g., a wireless interface) may be omitted from the server 500. The processor 510 may include one or more intelligent hardware devices, e.g., a central processing unit (CPU), a microcontroller, an application specific integrated circuit (ASIC), etc. The processor 510 may comprise multiple processors (e.g., including at least one of an application processor, a DSP, a modem processor, a video processor, and/or a sensor processor, similar to that shown in FIG. 5). The memory 511 is a non-transitory storage medium that may include random access memory (RAM)), flash memory, disc memory, and/or read-only memory (ROM), etc. The memory 511 stores the software 512 which may be processor-readable, processor-executable software code containing instructions that are configured to, when executed, cause the processor 510 to operate as a special purpose computer programmed to perform the various functions described herein. Alternatively, the software 512 may not be directly executable by the processor 510 but may be configured to cause the processor 510, e.g., when compiled and executed, to operate as a special purpose computer to perform the various functions described herein. The description may refer only to the processor 510 performing a function, but this includes other implementations such as where the processor 510 executes software and/or firmware. The description may refer to the processor 510 performing a function as shorthand for one or more of the processors contained in the processor 510 performing the function. The description may refer to the server 500 performing a function as shorthand for one or more appropriate components of the server 500 performing the function. The processor 510 may include a memory with stored instructions in addition to and/or instead of the memory 511.

The transceiver 515 may include one or both of a wireless transceiver 540 or a wired transceiver 550 configured to communicate with other devices through wireless connections and wired connections, respectively. For example, the wireless transceiver 540 may include a transmitter 542 and receiver 544 coupled to one or more antennas 546 for transmitting (e.g., on one or more downlink channels) and/or receiving (e.g., on one or more uplink channels) wireless signals 548 and transducing signals from the wireless signals 548 to wired (e.g., electrical and/or optical) signals and from wired (e.g., electrical and/or optical) signals to the wireless signals 548. Thus, the transmitter 542 may include multiple transmitters that may be discrete components or combined/integrated components, and/or the receiver 544 may include multiple receivers that may be discrete components or combined/integrated components. The wireless transceiver 540 may be configured to communicate signals (e.g., with the base station 400 (such as a gNB), one or more other base stations, the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 550 may include a transmitter 552 and a receiver 554 configured for wired communication. The transmitter 552 may include multiple transmitters that may be discrete components or combined/integrated components, and/or the receiver 554 may include multiple receivers that may be discrete components or combined/integrated components. The wired transceiver 550 may be configured, e.g., for optical communication and/or electrical communication. The wired transceiver 550 (and/or wireless transceiver 540) may be used to communicate with one or more core network components (such as core network 170). The server 500 may communicate with a base station 400 via the core network 170 (such as to receive one or more measurement reports including positioning measurements and/or RF sensing measurements, to provide a configuration for a positioning session or for an RF sensing session, to initiate a positioning session or an RF sensing session, or to provide other signals for operations of a wireless network).

The configuration of the server 500 shown in FIG. 5 is an example and not limiting of the disclosure, including the claims, and other configurations may be used. For example, the wireless transceiver 540 may be omitted. Also or alternatively, the description herein discusses that the server 500 is configured to perform or performs several functions, but one or more of these functions may be performed by a base station 400 and/or a UE 300.

The memory 511 may store software 512 that contains executable program code or software instructions that when executed by the processor 510 may cause the processor 510 to operate as a special purpose computer programmed to perform the functions disclosed herein. As illustrated, the memory 511 may include one or more components or modules that may be implemented by the processor 510 to perform the disclosed functions. While the components or modules are illustrated as software 512 in memory 511 that is executable by the processor 510, it should be understood that the components or modules may be stored in another computer readable medium or may be dedicated hardware either in the processor 510 or off the processor. A number of software modules and data tables may reside in the memory 511 and be utilized by the processor 510 in order to manage both communications and the functionality described herein. It should be appreciated that the organization of the contents of the memory 511 as shown is merely exemplary, and as such the functionality of the modules and/or data structures may be combined, separated, and/or be structured in different ways depending upon the implementation.

The memory 511, for example, may include positioning session module 572 that when implemented by the processor 510 configures the processor 510 to engage in supporting a positioning session, such as providing configurations for a positioning session (including the RSs to be used, other signaling parameters, and other parameters), collecting positioning measurements calculated by UEs and/or base stations, calculating a positioning of the UE based on the measurements, etc. The memory 511 may also include RF sensing session module 574 that when implemented by the processor 510 configures the processor 510 to engage in supporting an RF sensing session, such as providing configurations for an RF sensing session (including the RSs to be used, number of paths to be used, other signaling parameters, and other parameters), collecting RF sensing measurements calculated by UEs and/or base stations, calculating relative locations of objects with reference to a measuring device (or other object information) based on the measurements, etc. While the positioning session module 572 and the RF sensing session module 574 are depicted as being software included in memory 511, the positioning session module 572 and the RF sensing session module may be a hardware module, a software module, or a combination of hardware and software. For example, one or both modules may include one or more application specific integrated circuits (ASICs), executable code, or a combination of both.

During positioning using signaling in LTE and 5G NR, a UE may acquire dedicated positioning signals transmitted by base stations, e.g., a positioning reference signal (PRS), which are used to generate the desired positioning (position) measurements for the supported positioning technique, e.g., an AoA, ZoA and/or TOA. PRS is defined for 5G NR positioning to enable UEs to detect and measure neighbor base stations or Transmission and Reception Points (TRPs). Downlink (DL) PRS may be received by a UE from a reference base station and/or one or more neighboring stations and used to generate the desired measurements for the supported positioning technique, e.g., an AoA, ZoA, and/or TOA. Based on the TOA of the PRS from the reference and neighboring base stations, the UE may generate DL Reference Signal Time Difference (RSTD) for DL TDOA positioning, sometimes referred to as Observed Time Difference of Arrival (OTDOA). In a similar process, the UE may transmit uplink (UL) references signals for positioning, referred to as Sounding Reference Signals (SRS) for positioning to a reference base station and neighboring base stations. A base station may receive an SRS and generate the desired measurements for the supported positioning technique, e.g., an AoA, ZoA, and/or TOA. The TOAs of the SRS at the reference and neighboring stations may be used to generate an UL RSTD of UL TDOA positioning, sometimes referred to as UL Time Difference of Arrival (UTDOA). The positioning measurements may be provided to the location server to determine a location of the UE in the wireless network or to perform other operations of the wireless network (such as cell selection, navigation, or other operations). As used herein, a positioning measurement may be referred to as a UE positioning measurement, a UE position measurement, a UE location measurement, or other similar terms. A UE positioning measurement is a measurement of a position of a UE with reference to a base station. A UE positioning measurement may refer to a positioning measurement measured by a base station using one or more SRSs from a UE or a positioning measurement measured by a UE using one or more PRSs from a base station. As such, the phrase “UE positioning measurement” does not necessarily indicate the device performing the measurement and “positioning measurement” and “UE positioning measurement” may be used interchangeably throughout the present disclosure.

During a positioning session, a location server, base station, and/or UE may exchange messages defined according to a positioning protocol in order to coordinate the determination of an estimated location. Possible positioning protocols may include, for example, the LTE Positioning Protocol (LPP) defined by 3GPP in 3GPP TS 36.355 and the LPP Extensions (LPPe) protocol defined by OMA in OMA TSs OMA-TS-LPPe-V1_0, OMA-TS-LPPe-V1_1 and OMA-TS-LPPe-V2_0. The LPP and LPPe protocols may be used in combination where an LPP message contains one embedded LPPe message. The combined LPP and LPPe protocols may be referred to as LPP/LPPe. LPP and LPP/LPPe may be used to help support the 3GPP control plane solution for LTE or NR access, in which case LPP or LPP/LPPe messages may be exchanged between a UE and E-SMLC or between a UE and LMF. LPP or LPPe messages may be exchanged between a UE and E-SMLC via a serving Mobility Management Entity (MME) and a serving eNodeB for the UE. LPP or LPPe messages may also be exchanged between a UE and LMF via a serving Access and Mobility Management Function (AMF) and a serving NR Node B or gNodeB (gNB) for the UE. LPP and LPP/LPPe may also be used to help support the OMA SUPL solution for many types of wireless access that support IP messaging (such as LTE, NR and WiFi), where LPP or LPP/LPPe messages are exchanged between a SUPL Enabled Terminal (SET), which is the term used for a UE with SUPL, and an SLP, and may be transported within SUPL messages such as a SUPL POS or SUPL POS INIT message

A location server and a base station (e.g., an eNodeB for LTE access or a gNB for NR access) may exchange LPP or NR positioning protocol (NRPP) messages to enable the base station to perform one or more measurements for positioning or to configure the location server and base station to obtain by the location server position measurements for a particular UE from the base station. In the case of LTE access, the LPP A (LPPa) protocol may be used to transfer such messages between a base station that is an eNodeB (eNB) and a location server that is an E-SMLC. In the case of NR access, the NRPP A protocol may be used to transfer such messages between a base station that is a gNodeB (gNB) and a location server that is an LMF. It is noted that the terms “parameter” and “information element” (IE) are synonymous and are used interchangeably herein.

To support positioning of a UE, two broad classes of positioning solutions have been defined: control plane based and user plane based. With reference to control plane (CP) positioning, signaling related to positioning and support of positioning may be carried over existing network (and UE) interfaces and using existing protocols dedicated to the transfer of signaling. With reference to user plane (UP) positioning, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane positioning solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). For UP positioning, release 16 of the 3GPP standard for NR defines multi-cell round trip time (RTT), DL angle of departure (AoD), and UL angle of arrival (AoA) with zenith and azimuth. Release 16 also defines UE-based positioning associated with DL-TDOA and DL-AOD, DL-positioning reference signal (PRS) (DL-PRS), and sounding reference signal (SRS) for positioning. Release 16 also defines beam-specific (PRS) operation for mmWave and broadcasting of assistance data for positioning. Release 17 of the 3GPP standard for NR may define UE-initiated on-demand transmission of a DL-PRS, network-initiated on-demand transmission of a DL-PRS, Radio Resource Control (RRC) inactive DL-only, UL-only, or DL+UL based positioning, access point (AP) DL-PRS transmission, and/or aggregation of DL-PRS across multiple frequencies. Release 17 of the 3GPP standard for NR may also device transmission of sounding reference signals (SRS) from a UE on an uplink to a base station. The Open Mobile Alliance (OMA) has similarly defined a UP positioning solution known as Secure User Plane Location (SUPL), which can be used to locate a UE accessing any of a number of radio interfaces that support IP packet access such as General Packet Radio Service (GPRS) with GSM, GPRS with UMTS, or IP access with LTE or NR.

Both CP and UP based positioning (also referred to as location or locationing) solutions may employ a location server to support positioning of a UE. As depicted in FIG. 1, the location server may be part of or accessible from a serving network or a home network for a UE or may simply be accessible over the Internet or over a local Intranet. For a location server in or coupled to a core network, the location server may implement a location management function (LMF). If positioning of a UE is needed, a location server may instigate a session (e.g. a positioning session or a SUPL session) with the UE and coordinate position measurements for the UE to determine an estimated position of the UE. During a positioning session, a location server may request positioning capabilities of a UE or base station (or the UE or base station may provide them without a request) and may request a position estimate or position measurements for a UE for various positioning techniques, e.g., for the Global Navigation Satellite System (GNSS), Time Difference of Arrival (TDOA), Angle of Departure (AoD), Round Trip Time (RTT) or multi cell RTT (Multi-RTT), and/or Enhanced Cell ID (ECID) position methods.

In the case of 3GPP CP positioning, a location server may be an enhanced serving mobile location center (E-SMLC) in the case of LTE access, a standalone SMLC (SAS) in the case of UMTS access, a serving mobile location center (SMLC) in the case of GSM access, or a Location Management Function (LMF) in the case of 5G NR access. In the case of OMA SUPL positioning, a location server may be a SUPL Location Platform (SLP) which may act as any of: (i) a home SLP (H-SLP) if in or associated with the home network of a UE or if providing a permanent subscription to a UE for positioning services; (ii) a discovered SLP (D-SLP) if in or associated with some other (non-home) network or if not associated with any network; (iii) an Emergency SLP (E-SLP) if supporting positioning for an emergency call instigated by the UE; or (iv) a visited SLP (V-SLP) if in or associated with a serving network or a current local area for a UE.

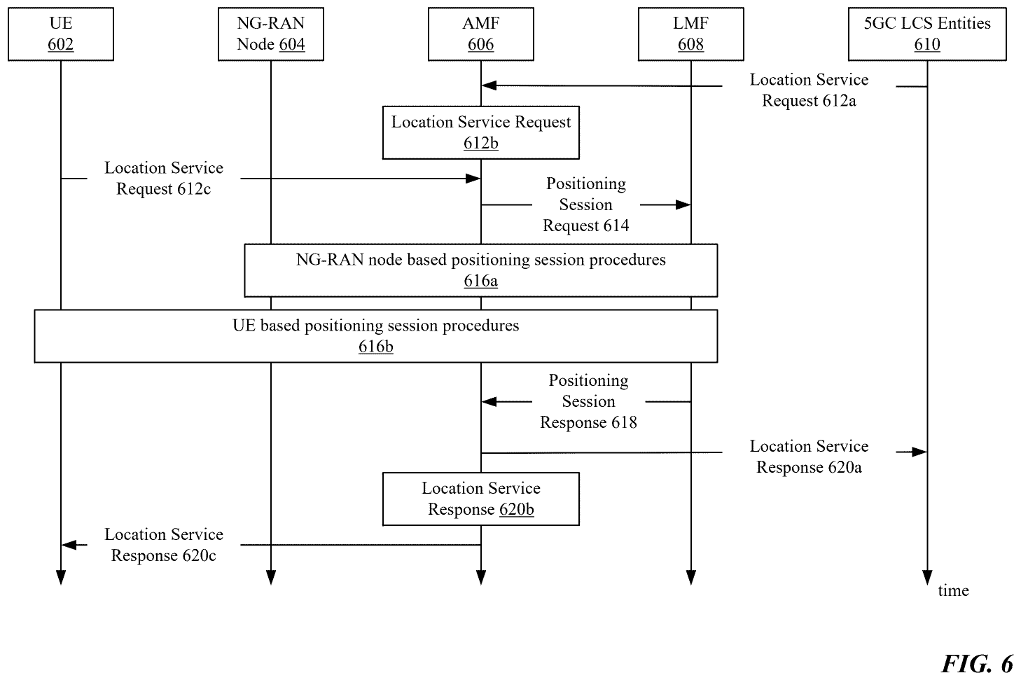

FIG. 6 illustrates a timing diagram depicting an example signaling flow for a positioning session in a 5G NR network. The framework is defined for NR, in which a UE 602 or a base station (i.e., a next generation radio access network (NG-RAN) node 604, which may be a gNB or a NG-eNB) may calculate one or more positioning measurements during a positioning session. The UE 602 may be an example implementation of a UE 104 or a UE 300. The NG-RAN node 604 may be an example implementation of a base station 102 or a base station 400. The NR network may also include an AMF 606, an LMF 608, and one or more 5G core location services (5GC LCS) entities. The LMF 608 may be an example implementation of the location server 172 or the server 500. A 5G LCS entity may be any suitable core network entity, such as defined for NR.

As shown, a location service may be requested by a 5GC LCS entity 610 (depicted as request 612a), the AMF 606 (depicted as 612b), or either of the UE 602 or NG-RAN node 604 (depicted as 612c). For example, a mapping application at another device may require the location of the UE 602 in the NR network and thus the location may be requested from the AMF 606 in the NR network. In another example, the UE 602 or the base station may request the location of the UE 602 for performing one or more network or UE related operations (such as cell handover operations, cell selection operations, UE navigation operations, etc.). In a further example, the AMF 606 may generate a request to periodically update the location of the UE or positioning information for the UE that is stored in the location server (such as the LMF 608). With the location service request being received or generated by the AMF 606 (either 612a, 612b, or 612c), the AMF 606 sends a positioning session request 614 to the LMF 608 for the LMF 608 to initiate one or more positioning sessions with the UE 602 and the NG-RAN node 604.

For UL based positioning in which a base station is to receive an SRS or another suitable RS from a UE, the LMF 608 may initiate the NG-RAN node 604 to perform the NG-RAN node based positioning session procedures 616a. For example, the LMF 608 may indicate to the NG-RAN node 604 (such as via the AMF 606 and/or other core network components) which RSs are to be received and which positioning measurements are to be calculated from the received RSs. The NG-RAN node 604 may receive the RSs (such as one or more SRSs), calculate the positioning measurements, generate one or more measurement reports including the positioning measurements, and provide the one or more measurement reports to the LMF 608.

Alternatively, for DL based positioning in which a UE is to receive a PRS or another suitable RS from a base station, the LMF 608 may initiate the UE 602 to perform the UE based positioning session procedures 616b. For example, the LMF 608 may indicate to the UE 602 (such as via the AMF 606 and the NG-RAN node 604) which RSs are to be received and which positioning measurements are to be calculated from the received RSs. The UE 602 may receive the RSs (such as one or more PRSs), calculate the positioning measurements, generate one or more measurement reports including the positioning measurements, and provide the one or more measurement reports to the LMF 608 (such as via the NG-RAN node 604).

With the LMF 608 receiving the positioning measurements from the NG-RAN node 604 or from the UE 602, the LMF 608 is able to calculate a location or position (or other position based information) of the UE 602 with reference to the NG-RAN node 604 or otherwise within the coverage area of the NR network. Such positioning information may be used to determine one or more network operations to be performed, may be used for a navigation application, or otherwise may be used by one or more devices in the NR network. As such, the LMF 608 may provide such information to the AMF 606 in a positioning session response 618 to the positioning session request 614.

The AMF 606 may then provide such information, network operations to be performed based on such information, or any other suitable location service information to the entity originally requesting the location service. For example, if a 5GC LCS entity 610 requested the location service (612a), the AMF 606 may provide a location service response 620a to the 5GC LCS entity 610 with the requested information. If the AMF 606 requested the location service (612b), the AMF 606 may use the location service information as desired (such as for management of the NR network). If the UE 602 or the NG-RAN node 604 requested the location service (612c), the AMF 606 may provide a location service response 620c to the UE 602 (via the NG-RAN node 604) or to the NG-RAN node 604 with the requested information.

With such a framework for generating and reporting positioning measurements defined for an NR network, the same framework may also be used for RF sensing. For example, because of the large bandwidth of the PRS, the PRS may be used for RF sensing (such as in calculating a doppler measurement between two devices). Similarly, the bandwidth of the SRS may be sufficient for RF sensing. In this manner, a device may transmit an RS (such as a base station transmitting a PRS or a UE transmitting an SRS), receive a reflection of the RS, and calculate one or more RF sensing measurements from the reflection. Alternatively, the device may receive a reflection of an RS transmitted by another device and calculate one or more RF sensing measurements from the reflection. To note, for UE positioning, a device may calculate positioning measurements for, e.g., eight paths between a UE and the network. For RF sensing, the “paths” may be substituted for neighboring objects such that a device is able to calculate RF sensing measurements for, e.g., eight neighboring objects of the measuring device. For example, instead of using a PRS or an SRS to calculate one or more positioning measurements, a base station or a UE may transmit a PRS or an SRS, respectively, receive eight reflections of the respective RS, and calculate RF sensing measurements for the received reflections. As used herein, receiving a reference signal may refer to receiving the reference signal directly from another device transmitting the reference signal or receiving a reflection of the reference signal originally transmitted by the receiving device or by another device. Example RF sensing measurements may include, e.g., a range of an object (such as a tx-rx time difference, an RTT, etc.), a doppler measurement, an angle of the RS, or a micro-doppler measurement. To note, some of the RF sensing measurements may be the same as some of the positioning measurements (such as an AoA of the RS). The RF sensing measurements may also include one or more of a class of the object (such as whether the object is a person, a car, etc.), a size of the object, a surface material of the object, or a radar cross section (RCS) of the object.

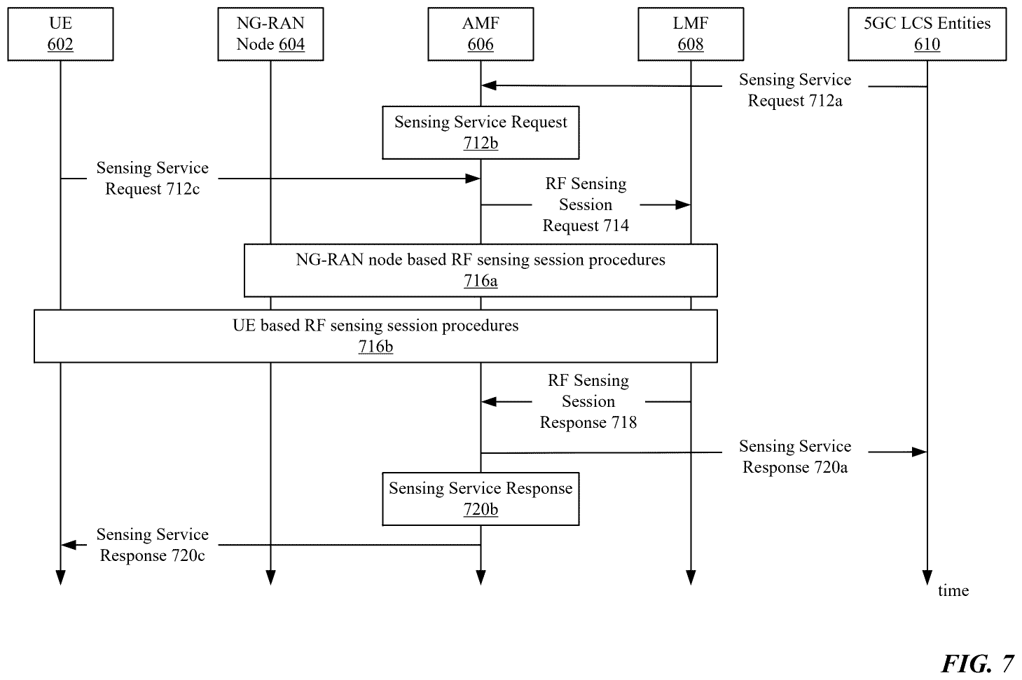

FIG. 7 illustrates a timing diagram depicting an example signaling flow for an RF sensing session in a 5G NR network. The framework of the positioning session as defined for NR (depicted in FIG. 5, in which a UE 602 or a NG-RAN node 604 may calculate one or more positioning measurements during a positioning session) is used for an RF sensing session.

Similar to requesting a location service, a sensing service may be requested by a 5GC LCS entity 610 (depicted as request 712a), the AMF 606 (depicted as 712b), or either of the UE 602 or NG-RAN node 604 (depicted as 712c). For example, a mapping application at another device may require the object information for the environment of the UE 602 or the NG-RAN node 604 in the NR network and thus such information may be requested from the AMF 606 in the NR network. In another example, the UE 602 or the base station may request to initiate the sensing service for performing one or more network or UE related operations (such as environment mapping of the requesting device, object avoidance or navigation of the UE, etc.). In a further example, the AMF 606 may generate a request to periodically update object information for the UE or NG-RAN node that is stored in the location server (such as the LMF 608). With the sensing service request being received or generated by the AMF 606 (either 712a, 712b, or 712c), the AMF 606 sends an RF sensing session request 714 to the LMF 608 for the LMF 608 to initiate one or more RF sensing sessions with the UE 602 or the NG-RAN node 604. In comparing FIG. 6 and FIG. 7, 612a-614 are similar to 712a-714.

If an RF sensing session is to be performed by the NG-RAN node 604, the LMF 608 may initiate the NG-RAN node 604 to perform the NG-RAN node based RF sensing session procedures 716a. For example, the LMF 608 may indicate to the NG-RAN node 604 (such as via the AMF 606 and/or other core network components) which RSs are to be received and which RF sensing measurements are to be calculated from the received RSs. If the NG-RAN node 604 is to initially transmit the RS, too, the LMF 608 may indicate such to the NG-RAN node 604. As noted above, receiving a RS for an RF sensing session may refer to receiving a reflection of the RS off of an object. In this manner, the RF sensing measurements or associated with the object reflecting the RS. The NG-RAN node 604 may receive the RSs (such as one or more reflections of a PRS), calculate the RF sensing measurements, generate one or more measurement reports including the RF sensing measurements, and provide the one or more measurement reports to the LMF 608.

Alternatively, if an RF sensing session is to be performed by the UE 602, the LMF 608 may initiate the UE 602 to perform the UE based RF sensing session procedures 716b. For example, the LMF 608 may indicate to the UE 602 (such as via the AMF 606 and the NG-RAN node 604) which RSs are to be received and which RF sensing measurements are to be calculated from the received RSs. The UE 602 may receive the RSs (such as one or more reflections of an SRS), calculate the RF sensing measurements, generate one or more measurement reports including the RF sensing measurements, and provide the one or more measurement reports to the LMF 608 (such as via the NG-RAN node 604).

With the LMF 608 receiving the RF sensing measurements from the NG-RAN node 604 or from the UE 602, the LMF 608 is able to calculate information regarding the environment of the UE 602 or of the NG-RAN node 604. Such information may be used to determine directions for obstacle avoidance, may be used for a navigation application, may be used for environment mapping, or otherwise may be used by one or more devices in the NR network. As such, the LMF 608 may provide such information to the AMF 606 in an RF sensing session response 718 to the RF sensing session request 714.

The AMF 606 may then provide such information, network operations to be performed based on such information, or any other suitable sensing service information to the entity originally requesting the sensing service (such as depicted by responses 720a-720c corresponding to requests 712a-712c, respectively). In comparing FIG. 6 and FIG. 7, 618-620c may be similar to 718-720c. To note, measurement reporting that may occur during 616 and 716 may be merged such that the measurement reports include the positioning measurements and the RF sensing measurements. For example, a first portion of measurement reports may include positioning measurements, and a second portion of measurement reports may include RF sensing measurements. In another example, a measurement report may include both positioning measurements and RF sensing measurements. As such, a device performing positioning sessions and RF sensing sessions may use its existing architecture configured for both types of sessions to provide both types of measurements for various positioning and RF sensing applications. Referring to FIGS. 6 and 7, since calculating measurements and generating measurement reports may occur for both RF sensing sessions and positioning sessions, the positioning session procedures of 616a or 616b may occur concurrently or within a short amount of time of the RF sensing session procedures of 716a or 716b. Example implementations of generating positioning measurements, generating RF sensing measurements, and reporting at least a portion of such measurements is described below with reference to the Figures.

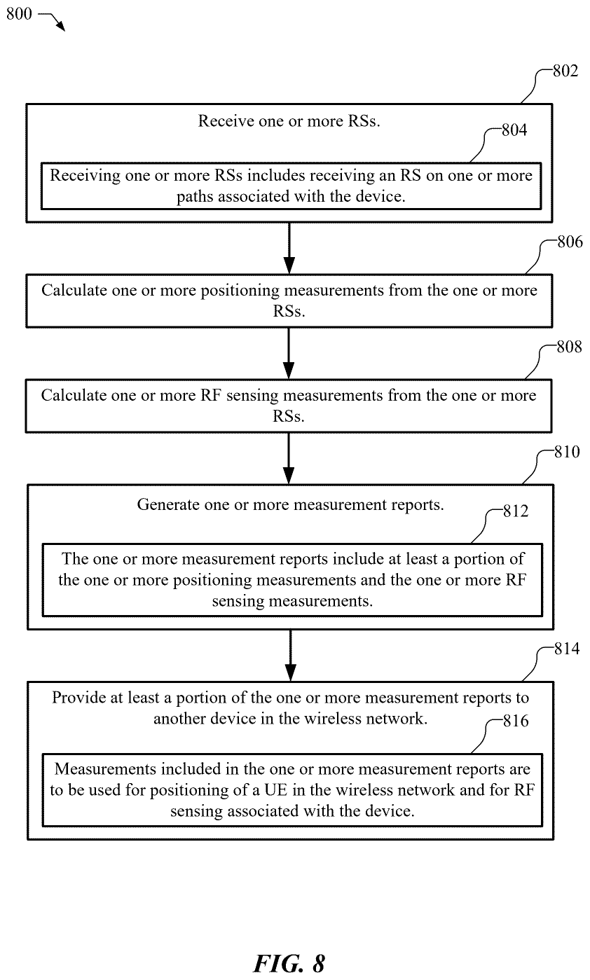

FIG. 8 shows a flowchart for an exemplary method 800 for performing RF sensing and positioning sessions in a wireless network. The exemplary method 800 may be performed by any suitable device in a wireless network, such as a UE 104 or a base station 102 shown in FIG. 1, in a manner consistent with disclosed implementations. A device that may perform one or more operations in method 800 may include at least one transceiver (such as one or more wireless transceivers and/or one or more wired transceivers), at least one memory, and at least one processor coupled to the at least one transceiver and the at least one memory. Referring to the UE 300 as an example device, the at least one transceiver may include the transceiver 315 or the wireless transceiver 340, the at least one memory may include the memory 311, and the at least one processor may include one or more of the processor 310, or one or more of processors 330-334. Referring to the base station 400 as an example device, the at least one transceiver may include all or a portion of the transceiver 415 or the wireless transceiver 440, the at least one memory may include the memory 411, and the at least one processor may include the processor 410. A wireless transceiver may refer to one or more wireless transceivers, such as wireless transceiver 340 of UE 300 or wireless transceiver 440 of the base station 400.

At block 802, a device receives one or more reference signals (RSs). Means for receiving one or more reference signals may include a wireless transceiver (which may include one or more transceivers) of the device. For example, a device may be configured to perform one or more positioning sessions and one or more RF sensing sessions. If the device is a base station, the one or more reference signals may include one or more SRSs for UL based positioning. The one or more reference signals may also include reflections of one or more PRSs transmitted by the base station or reflections of one or more RSs (which may be SRSs or PRSs) for RF sensing. If the device is a UE, the one or more reference signals may include one or more PRSs for DL based UE positioning. The one or more reference signals may also include reflections of one or more SRSs transmitted by the UE or reflections of one or more RSs (which may be PRSs or SRSs) for RF sensing. In some implementations, the wireless network including a UE and base station is a cellular network. In some implementations, the base station is a gNB in an NR network.

The RSs may be defined by a location server (such as the location server 172 or the LMF 608). The location server may also define what measurements are to be calculated by a device from the RSs or other parameters regarding the RSs or the positioning or RF sensing sessions.

In some implementations of receiving one or more reference signals, the device receives several instances of a reference signal over time. For example, a UE may periodically transmit an SRS, or a base station may periodically transmit a PRS. A first positioning session or RF sensing session may be used to receive a first set of instances of the reference signal, a second positioning session or RF sensing session may be used to receive a second set of instances of the reference signal, and so on. While not depicted in FIG. 8, an RF sensing session may also be used to transmit the reference signal by the device in order to receive a reflection of that reference signal.

Receiving one or more reference signals includes receiving a reference signal on one or more paths associated with the device (804). For a positioning session, a path may be defined as a communicable coupling between devices in the wireless network and a target device. For example, a first path may be for communications between a first base station and a UE, and a second path may be for communications between a second base station and the UE. In some implementations, an RF sensing session may be implemented so that each path is used by a receiving device as being associated with an object. For example, for a first path in which a reflection of a RS is received, the first path is associated with the object that reflects the RS. In this manner, if the device is configured to calculate measurements for eight paths, the device may calculate RF sensing measurements associated with eight objects in the environment of the device.

At block 806, the device calculates one or more positioning measurements from the one or more RSs. For example, the device may calculate one or more of a per path RS receive power (RSRP) from the RS received on each path or a per path phase from the RS received on each path. Other example positioning measurements may include an AoA, a time of arrival (TOA), a transmit-receive time difference, etc. If the device is a UE, in some implementations, the UE may calculate an RSRP and a phase for a PRS received on each path. If the device is a base station, in some implementations, the base station may calculate an RSRP and a phase for a SRS received on each path.

At block 808, the device calculates one or more RF sensing measurements from the one or more RSs. In some implementations, the positioning measurements calculated in block 806 (such as the per path RSRP and the per path phase) may also be RF sensing measurements. For example, the per path RSRP may be used to calculate a range of an object associated with the path. The per path phase may be used to calculate a movement of the object with reference to the receiving device. In some implementations, calculating the one or more RF sensing measurements may also include calculating a per path doppler measurement from the RS received on each path. A doppler measurement may be any suitable measurement to estimate a doppler shift between the device and the object. For example, a doppler measurement may include the frequency shift of the RS between transmission and reception, a transmit-receive time difference that may be used in a sequence of such measurements to determine the frequency shift, etc. Calculating the one or more RF sensing measurements may also include calculating a per path angle estimation for the RS received on each path. For example, the device may calculate an AoA, which may indicate the direction of the object from the device.

Calculating the one or more RF sensing measurements may include calculating one or more RF sensing measurements associated with an object in the environment of the device. For example, as noted herein, the one or more RF sensing measurements may include one or more of a range of the object from the device (such as based on a transmit-receive time difference measurement), a doppler measurement associated with movement between the device and the object, an angle of the RS between the device and the object, or a micro-doppler measurement associated with the object. The one or more RF sensing measurements may also include one or more of a class of the object (such as whether the object is a car, a person, a static object (such as a tree or building), etc.), a size of the object, a surface material of the object, or a RCS of the object. In this manner, RF sensing measurements may be on a per object basis.

In some implementations, calculating the one or more RF sensing measurements includes generating for an RF sensing measurement one or more of a measurement quality of the RF sensing measurement or a time stamp associated with the RF sensing measurement. The measurement quality may include a signal to noise ratio (SNR) or any other suitable measurement to indicate the quality of the associated RF sensing measurement. The time stamp may include a value of a network timer at the device when calculating the RF sensing measurement or measurement quality. As described herein, the measurement quality and/or the time stamp may be reported to the location server or may be used to identify whether the underlying measurement quality is to be reported to the location server.

To note, blocks 806 and 808 are depicted in FIG. 8 as being separate and sequential blocks for simplicity in explaining aspects of the present disclosure. Operations of blocks 806 and 808 may be performed in any suitable order or may be performed concurrently. As such, the present disclosure is not limited to the depicted order of operations.

At block 810, the device generates one or more measurement reports. The one or more measurement reports include at least a portion of the one or more positioning measurements and the one or more RF sensing measurements (812). In some implementations, generating the one or more measurement reports includes including the one or more positioning measurements in one or more positioning measurement reports and including the one or more RF sensing measurements in one or more RF sensing measurement reports. In this manner, the positioning measurements and the RF sensing measurements are included in separate measurement reports. For an NR network, the positioning measurement reports are defined in 3GPP Release 17. For example, a positioning measurement report may be included in the NR-Multi-RTT-AdditionalMeasurementsElement information element (IE). As defined, the NR-Multi-RTT-AdditionalMeasurementsElement IE may include transmit-receive time difference measurements, a timing quality of the measurements, and a time stamp associated with the measurements. The IE may also include a list of additional paths for the device, a PRS resource ID, a PRS resource set ID, and/or an RSRP measurement. To note, measurements for or more paths may be included in the same measurement report. For example, the positioning measurement reports may be defined for a specific maximum number of paths (such as eight paths in Release 17). If the device is to report measurements for additional paths over the maximum per measurement report, additional measurement reports may be generated and reported.

For the separate RF sensing measurement reports, any suitable structure of an RF sensing measurement report may be used. For example, the RF sensing measurement report may be a newly created IE of a newly defined structured or may have a similar structure as the NR-Multi-RTT-AdditionalMeasurementsElement IE. The location server may indicate the structure of the RF sensing measurement report (such as the new IE) to be generated and reported as well as the RSs to be used in calculating the measurements for inclusion in the RF sensing measurement report. In some implementations, an RF sensing measurement report includes a doppler measurement calculated by the device. For example, for each path, the device may calculate a doppler measurement, and the doppler measurement may be included in the measurement report. If the measurement report is limited to eight paths, up to eight doppler measurements may be included in the same measurement report. The measurement report may also include the angle information for each path if the device supports calculating an angle of the RS.

Alternative to generating separate measurement reports for positioning measurements and RF sensing measurements, a positioning measurement and an RF sensing measurement may be included in the same measurement report. In this manner, generating the one or more measurement reports may include including at least one of the one or more positioning measurements and at least one of the one or more RF sensing measurements in a first measurement report. If the NR-Multi-RTT-AdditionalMeasurementsElement IE is to be used for reporting positioning measurements, the device may include the first measurement report including one or more RF sensing measurements in the NR-Multi-RTT-AdditionalMeasurementsElement IE.

To note, not all measurement reports are required to include a combination of positioning measurements and RF sensing measurements, and a device may be configured to include such measurements into one or more measurement reports in any suitable manner. Additionally or alternatively, a measurement may be for both RF sensing and for positioning. For example, an RSRP included in the NR-Multi-RTT-AdditionalMeasurementsElement IE may be both for positioning and for RF sensing. If positioning measurements and RF sensing measurements are included in the same measurement report, a combined measurement report may include a doppler measurement calculated by the device.

At block 814, the device provides at least a portion of the one or more measurement reports to another device in the wireless network. For example, a UE generating the measurement reports may transmit, via a wireless transceiver, one or more measurement reports to a base station, and the base station may forward the one or more measurement reports to a core network to be received by a location server. In another example, a base station generating the measurements reports may transmit, via a wired or wireless transceiver, one or more measurement reports to a core network to be received by a location server. If separate positioning measurement reports and RF sensing measurement reports are generated, the device may report at least a subset of the combined pool of measurement reports. If combined measurement reports are generated, the device may report at least a subset of the combined measurement reports generated.

Measurements included in the one or more measurement reports are to be used for positioning of a UE in the wireless network and for RF sensing associated with the device (816). For example, the location server may use the positioning measurements to determine a location of the UE in a coverage area of the wireless network. Such location may be used for a navigation application, cell selection in a cellular network, or other network operations. The location server may also use the RF sensing measurements (which may or may not include at least a portion of the positioning measurements, such as a per path RSRP or a per path phase) to detect objects in the environment of the device receiving the RSs. For example, if the device is a UE, the location server may map the location of objects in the environment of the UE based on doppler measurements reported to the location server. The location server may also calculate the type of objects or other information as desired. Such information may be used for obstacle avoidance applications, object identification, mapping applications associated with the UE, or other sensing based applications. If the device is a base station (such as a gNB), the location server may map the location (and calculate other information) of objects in the environment of the base station. Such information may be used for mapping the environment of the coverage area of the wireless network, obstacle avoidance for UEs travelling through the coverage area, navigation, or other sensing based applications. To note, a positioning application and a sensing application may overlap. For example, UE navigation may require both the location of the UE and obstacles in the environment of the UE in order to successfully provide navigation instructions for the UE through the coverage area of the wireless network. Alternatively, a positioning application and a sensing application may be mutually exclusive. For example, cell selection in a cellular network and obstacle detection for obstacle avoidance may be mutually exclusive applications.

To note, a doppler measurement may be based on multiple instances of RS resources received by the device. For example, a frequency shift may be measured over multiple instances of a PRS or SRS resource or over different resources of a PRS or SRS received over time. If separate RF sensing measurement reports are generated, the doppler measurements may be reported in any suitable manner (such as once for the batch of RS resources associated with the doppler measurement). However, if measurement reports are to include a combination of positioning measurements and RF sensing measurements, measurement reports originally defined for positioning that may be adjusted to include RF sensing measurements may be on a per resource ID and resource set ID basis. For example, as defined for positioning, the NR-Multi-RTT-AdditionalMeasurementsElement IE is reported on a unique resource/resource set basis (with the IE including the associated resource ID/resource set ID).

Since a doppler measurement may be over multiple RS resources, in some implementations, a combined measurement report may be duplicated for each resource ID/resource set ID associated with calculating a doppler measurement. In this manner, the same doppler measurement may be included in multiple instances of a measurement report. In some other implementations, the doppler measurement may be included in measurement reports for only a subset of the associated resource IDs/resource set IDs. For example, the location server may indicate that, for the last resource ID/resource set ID used for calculating a doppler measurement, the associated measurement report is to include the doppler measurement. In this manner, the device may be configured to report measurement reports including the doppler measurements for only a subset of resource IDs/resource set IDs. Additionally, not all PRS or SRS resources may be useful for RF sensing or for calculating specific types of RF sensing measurements. For example, if two RS resources are to be used to calculate a doppler measurement, a phase coherence between the RS resources is to be maintained in order for the device to be able to calculate the doppler measurement. If the phase coherence between two RS resources is not maintained, a doppler measurement (such as a frequency shift) cannot be calculated from the two RS resources. As such, it is not always desirable to calculate or report RF sensing measurements for certain RSs or RS resources, and a doppler measurement (or other suitable RF sensing measurement) may be added to a measurement report as necessary (such as defined by the location server). Alternatively, if separate RF sensing measurement reports are generated, the RF sensing measurement reports may be generated or reported as necessary (such as not for every RS resource/resource set).

For separate RF sensing measurement reports, each measurement report may be associated with a different object in the device's environment or may be associated with a different channel used to receive at least a portion of the one or more RSs. In some implementations, a measurement report is associated with an object. As such, a measurement report is to be generated for each object for which RF sensing measurements are calculated. As noted above, the RF sensing measurements may include one or more of a range, a doppler measurement, an RS angle, or a micro-doppler associated with an object. The RF sensing measurements may also include one or more of a class, a size, a material, or an RCS of an object. Such RF sensing measurements are per object, and such RF sensing measurements may be included in an RF sensing measurement report for each object being sensed in the device's environment.

Per object measurement reporting allows for simpler calculations to be required at the location server to reduce latency in determining further actions to be performed based on the RF sensing measurements. Time sensitive applications, such as certain obstacle avoidance and navigation applications, may be benefit from the latency sensitive nature of such RF sensing measurements and reporting. However, the use of per object measurement reports may have a significant impact on device computation and transmission overhead. For example, as the number of objects in a device's environment increases, the number of measurement reports increases. In addition, the device is required to perform additional calculations as the number of objects increases.

In some other implementations, each RF sensing measurement report may be associated with a unique channel used to receive a least a portion of the one or more RSs. In particular, each RF sensing measurement report may be associated with a unique channel estimation based on the reception of at least a portion of the one or more RSs by the device. For RF sensing measurement reports being channel based (associated with a channel estimation), receiving the one or more RSs includes receiving the one or more RSs on one or more channels (such as on one or more frequency channels defined for a cellular network). Instead of the device calculating a per object doppler measurement, range, or other type of RF sensing measurement, the device may calculate a channel impulse response (CIR) for each of the one or more channels used to receive the one or more RSs. Calculating the CIR on the channel may be for one or more time windows (thus creating one or more CIR measurements). The one or more CIR measurements may be included in the RF sensing measurement report associated with the channel. To note, the CIR of a channel may be quantized in any suitable manner, and the number of time windows over which to calculate a CIR may be any suitable number of time windows.

In this manner, RF sensing measurement reports are on a per channel basis. Since the number of channels remain the same independent of whether the number of objects in the environment decreases or increases, the number of RF sensing measurement reports to be generated may also remain the same independent of the number of objects in the environment. As such, the number of objects may not impact device processing resources or transmission overhead. In addition, calculating one or more CIR measurements per channel may be easier for a device than calculating other object based RF sensing measurements. However, operations at the location server may become more processing and time intensive at the location server to map objects in the device's environment. For example, with the CIR measurements received by a location server for per channel measurement reporting, the location server may implement more enriched algorithms than necessary for per object measurement reporting. In some implementations, the location server may implement one or more machine learning (ML) models to output information regarding objects in the device's environment based on an input of the CIR measurements to the one or more ML models. Any suitable ML model may be used, such as neural networks, Bayesian based models, etc., and training of an ML model may be supervised or unsupervised with any suitable form of feedback or reward system in order to optimize the output of the ML model.

As such, latency and processing requirements may increase using per channel RF sensing measurement reports as compared to per object RF sensing measurement reports. For latency critical applications, per object measurement reports may be preferred over per channel measurement reports. For device power saving (such as for battery constrained UEs) and transmission overhead savings, per channel measurement reports may be preferred over per object measurement reports.

There may exist limited bandwidth for reporting positioning measurements and RF sensing measurements. For example, for a UE, the location server may define specific portions of the UL to be used for transmitting measurement reports to a base station (which may then be provided to the location server). The amount of bandwidth required to report all measurements may be more than the bandwidth available to the device for reporting the measurements. As such, the device (and other entities in the wireless network) may be configured to prioritize specific measurements or measurement reports over other measurements or measurement reports. If a device is to report only a portion of measurements that may be calculated otherwise, the device may prevent calculating the portion of measurements not to be reported, may prevent generating one or more measurement reports, may exclude including one or more measurements in a measurement report, or may exclude reporting one or more measurement reports.

For combined measurement reports including both positioning measurements and RF sensing measurements (such as a modified NR-Multi-RTT-AdditionalMeasurementsElement IE), the device may prioritize the one or more positioning measurements and the one or more RF sensing measurements for inclusion in the one or more measurement reports. Prioritizing the one or more positioning measurements and the one or more RF sensing measurements may include prioritizing the positioning measurements over the RF sensing measurements or prioritizing the RF sensing measurements over the positioning measurements. In some implementations, prioritizing the one or more positioning measurements and the one or more RF sensing measurements may be based on a latency requirement. For example, a latency requirement of a positioning application (such as UE navigation) may have a more critical latency requirement than a sensing application (such as generating a map of the ecosystem). As such, positioning measurements may be prioritized over RF sensing measurements. In this manner, if the allocated bandwidth for reporting is not sufficient for all measurements to be reported, the device may exclude one or more RF sensing measurements first (before excluding any positioning measurements) until the bandwidth allocation for reporting may be met. For example, a location server may allocate resources of an UL from a UE to provide positioning measurement reports (such as defined IEs for positioning). The same allocation may also be used to report RF sensing measurements (such as in the positioning measurement reports or in separate measurement reports). However, allocation for reporting the measurements may be performed in any suitable manner.

In some other implementations, prioritizing the one or more positioning measurements and the one or more RF sensing measurements may be based on a size of the positioning measurements and a size of the RF sensing measurements. For example, if RF sensing measurements are on a per object basis, the number of objects impacts the collective size of RF sensing measurements. For positioning measurements, the number of transmit receive points (TRPs) from which RSs are received (such as from a base station or a UE) impacts the collective size of positioning measurements. In some implementations, the smaller size measurements may be prioritized over the larger size measurements in order to meet the bandwidth allocation for reporting measurements.

Prioritization of the RF sensing measurements and the positioning measurements may be based on any suitable prioritization rules that may be defined in any suitable manner. In some implementations, prioritizing the one or more positioning measurements and the one or more RF sensing measurements is based on one or more priority rules indicated by a location server. For example, during configuration of the RF sensing sessions and/or the positioning sessions to be performed, the location server may indicate rules as to how to prioritize the positioning measurements and the RF sensing measurements for combined measurement reports to be reported. In this manner, the UE and the base station may follow the priority rules if all measurements cannot be reported in the allocated bandwidth (such as a limited UL resource from the UE to the base station). Indicating the prioritization by the location server may be performed in any suitable manner.

In some implementations, prioritizing the one or more positioning measurements and the one or more RF sensing measurements includes prioritizing the one or more positioning measurements over the one or more RF sensing measurements by default. For example, if prioritization rules are not received by a UE and a base station from a location server in a cellular network, the UE and the base station may default to prioritizing positioning measurements over RF sensing measurements. In this manner, RF sensing measurements are included in a combined measurement report only if sufficient bandwidth exists to include any RF sensing measurements after including the positioning measurements.

In some implementations, prioritizing the one or more positioning measurements and the one or more RF sensing measurements includes prioritizing positioning measurements and RF sensing measurements associated with a serving cell and one or more neighboring cells over positioning measurements and RF sensing measurements not associated with the serving cell and the one or more neighboring cells. For example, RF sensing measurements associated with a tree, a person, or another object that is not one of the cells of interest to a UE may be of lower priority than a positioning or RF sensing measurement associated with a base station currently serving the UE. In this manner, measurements that may be used for operations in the wireless network (such as cell selection) are prioritized for reporting to the location server over other measurements. Such other measurements may be included in the measurement reports only if the other prioritized measurements are already included in the measurements reports and sufficient bandwidth exists for inclusion of such measurements.

In some implementations, the prioritization rules may be defined in a standard to which the network entities are compliant (such as defined by the 3GPP or another suitable standards organization). In some other implementations, the prioritization rules may be proprietarily defined, with all necessary entities in the wireless network complying with the same set of prioritization rules.

Other than prioritization being based on an allocated bandwidth or overhead of reporting, some measurements may be of insufficient quality to be of use to the location server. For example, an RSRP may be so low that it is close to an ambient noise on the channel used to receive the RS. In some implementations, whether a measurement is to be reported may be based on a quality of the measurement. As noted above, for each of the one or more RF sensing measurements, the device may calculate a measurement quality associated with the RF sensing measurement. For example, the device may measure an SNR of the RS used to calculate the RF sensing measurement. The device may exclude at least one RF sensing measurement from the one or more measurement reports based on the associated measurement quality. In some implementations, the measurement quality may be compared to a defined threshold for each RF sensing measurement. For example, a minimum SNR may be defined for the RF sensing measurements. If the measurement quality does not meet the defined threshold (such as a measured SNR not being above a minimum SNR), the device may not include the RF sensing measurement in a measurement report to be reported to the location server, as the RF sensing measurement may be considered of such low quality that the measurement could be inaccurate. To note, a measurement quality threshold may be any suitable threshold and may be defined in any suitable manner. For example, the location server may indicate the threshold, the threshold may be defined by a standard, the threshold may be set or adjusted by a user, etc.

As described above, one or more RF sensing measurements may be excluded from one or more measurement reports. In some implementations, if the device excludes one or more RF sensing measurements from the one or more measurement reports, the device may indicate that at least one RF sensing measurement is excluded from the one or more measurement reports. For example, an IE transmitted by a UE to the base station and including the measurement report may be configured to include a flag or other indicator that one or more RF sensing measurements are excluded from the one or more measurement reports. In this manner, the location server may be apprised that one or more RF sensing measurements are missing. Based on such indication, the location server may increase the bandwidth allocation for reporting the measurements or otherwise manage the positioning and RF sensing sessions.

Described above are example implementations for prioritizing measurements and excluding one or more measurements from one or more combined measurement reports. If the device is configured to generate separate positioning measurement reports and RF sensing measurement reports, prioritization may include prioritizing the positioning measurement reports and the RF sensing measurement reports. For example, positioning measurement reports may be prioritized over RF sensing measurement reports, or RF sensing measurement reports may be prioritized over positioning measurement reports. Prioritizing the measurement reports may be based on similar parameters as described above for prioritizing measurements themselves for combined measurement reports.

In some implementations, prioritizing the one or more positioning measurement reports and the one or more RF sensing measurement reports is based on a latency requirement. For example, if a positioning application (such as UE navigation) requires a specific latency as compared to a sensing application, the positioning measurement reports may be prioritized over the RF sensing measurement reports. As is evident, prioritizing the different types of measurement reports (or the different types of measurements themselves) may be based on the use case. In some other implementations, prioritizing the one or more positioning measurement reports and the one or more RF sensing measurement reports is based on a size of the positioning measurement reports and a size of the RF sensing measurement reports. For example, the collection of positioning measurements may be of a different size than the collection of RF sensing measurements. If each measurement report is of a fixed size (or of a fixed content), the number of measurement reports per type may differ (or the size of each report may differ) based on the collective size difference of the measurements. For example, per object RF sensing measurement reports for a large number of objects may be of a larger size than the positioning measurement reports. As such, the device may prioritize the smaller size measurement reports (such as the positioning measurement reports in the above example). In some implementations, prioritizing the one or more positioning measurement reports and the one or more RF sensing measurement reports is based on one or more priority rules indication by a location server. In some other implementations, the one or more positioning measurement reports may be prioritized over the one or more RF sensing measurement reports by default. For example, if an indication of the priority rules are not received from the location server at, e.g., the UE and base station, the UE may prioritize transmitting to the base station over an UL the positioning measurement reports over the RF sensing measurement reports. In some implementations, prioritizing the one or more positioning measurement reports and the one or more RF sensing measurement reports includes prioritizing positioning measurement reports and RF sensing measurement reports associated with a serving cell and one or more neighboring cells over positioning measurement reports and RF sensing measurement reports not associated with the serving cell and the one or more neighboring cells.

As noted above, excluding an RF sensing measurement from a combined measurement report may be based on a measurement quality of the RF sensing measurement (such as an SNR associated with the RF sensing measurement being less than a minimum SNR). Similarly for RF sensing measurement reports, the device may calculate a measurement quality for each of the one or more RF sensing measurements (such as an SNR of the received RS associated with calculating the RF sensing measurement), and the device may exclude at least one RF sensing measurement from the one or more RF sensing measurement reports based on the associated measurement quality (such as if the SNR is less than a minimum SNR defined for the RF sensing measurements).

If the device excludes at least one RF sensing measurement report from being reported, the device may indicate that at least one RF sensing measurement report is excluded from being reported. Implementations of indicating that a measurement report is not being reported may be similar to implementations described above that a measurement is not being included in a measurement report. For example, a measurement report that is reported may include an indication.

In excluding a measurement from being included in a measurement report or excluding a measurement report from being reported, the device may drop the measurement or the measurement report from a memory such that it is no longer available. Alternatively, the device may prevent a measurement from being calculated or a measurement report from being generated if not to be reported. For example, if a latency requirement indicates that positioning measurements are of higher priority and an allocated bandwidth for reporting only allows a first number of RF sensing measurements or a first number of RF sensing measurement reports, the device may be configured to exclude calculating additional RF sensing measurements or generating additional RF sensing measurement reports greater than the first number. While some examples are provided herein, any suitable implementations may be used for excluding reporting one or more measurements or one or more measurement reports.

As noted above, in some implementations, RF sensing measurement reports are on a per channel basis. For example, the device calculates a CIR measurement over a plurality of time windows for a wireless channel, and the plurality of CIR measurements are to be included in an RF sensing measurement report associated with the wireless channel. With a limited bandwidth to report positioning measurement and RF sensing measurements, the number of CIR measurements (based on the number of channels and the number of time windows) may cause the bandwidth of the totality of the measurement reports to be greater than the bandwidth allocated for reporting.

In some implementations of excluding one or more measurements from being reported, the one or more RF sensing measuring reports (which are on a per channel basis) may exclude one or more CIR measurements associated with one or more time windows from being included in an RF sensing measurement report. In this manner, the device may calculate the CIR measurements for all of the defined time windows but then pare down the CIR measurements to be included in the measurement reports. Paring down the CIR measurements in the measurement reports may be based on any suitable parameter, such as a latency requirement or a use case of the device, a maximum time between successive CIR measurements reported for a channel, etc. Alternative to calculating all of the CIR measurements and excluding a portion of the CIR measurements from the one or more RF sensing measurement reports, the device may prevent calculating one or more CIR measurements for one or more time windows. In this manner, the device calculates the CIR measurement for a channel for a first subset of a plurality of time windows, and the device prevents calculating the CIR measurement for the channel for a second subset of the plurality of time windows. The time windows to be used may be selected in any suitable manner, such as a latency requirement or a use case of the device, a maximum time between successive CIR measurements reported for a channel, etc.

As described above, a device (such as a UE or a base station, which may be, e.g., a gNB) may be configured to perform positioning sessions and RF sensing sessions in order to calculate and report positioning measurements and RF sensing measurements. The device may also prioritize such measurements for reporting. In this manner, devices in a wireless network (such as a cellular network) may be configured to perform both UE positioning and RF sensing services concurrently.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:
1. A method performed by a device for performing radio frequency (RF) sensing in a cellular network, the method including:
receiving one or more reference signals (RSs), where receiving one or more RSs includes receiving an RS on one or more paths associated with the device;
calculating one or more positioning measurements from the one or more RSs;
calculating one or more RF sensing measurements from the one or more RSs;
generating one or more measurement reports, where the one or more measurement reports include at least a portion of the one or more positioning measurements and the one or more RF sensing measurements; and
providing at least a portion of the one or more measurement reports to another device in the cellular network, where measurements included in the one or more measurement reports are to be used for positioning of a user equipment (UE) in the cellular network and for RF sensing associated with the device.
2. The method of clause 1, where calculating the one or more positioning measurements includes one or more of:
calculating a per path RS receive power (RSRP) from the RS received on each path, where the one or more RF sensing measurements may also include the per path RSRP; or
calculating a per path phase from the RS received on each path, where the one or more RF sensing measurements may also include the per path phase.
3. The method of clause 1, where calculating the one or more RF sensing measurements includes calculating a per path Doppler measurement from the RS received on each path.
4. The method of clause 3, where calculating the one or more RF sensing measurements also includes calculating a per path angle estimation for the RS received on each path.
5. The method of clause 1, where calculating the one or more RF sensing measurements includes generating, for at least one other RF sensing measurement, one or more of:
a measurement quality of the RF sensing measurement; or
a time stamp associated with the RF sensing measurement.
6. The method of clause 1, where generating the one or more measurement reports includes including at least one of the one or more positioning measurements and at least one of the one or more RF sensing measurements in a first measurement report.
7. The method of clause 6, where providing the at least portion of the one or more measurement reports to another device includes providing the first measurement report in an NR-Multi-RTT-AdditionalMeasurementElement information element (IE).
8. The method of clause 6, further including prioritizing the one or more positioning measurements and the one or more RF sensing measurements for inclusion in the one or more measurement reports.
9. The method of clause 8, where prioritizing the one or more positioning measurements and the one or more RF sensing measurements includes prioritizing, based on a latency requirement, one of:
positioning measurements over RF sensing measurements; or
RF sensing measurements over positioning measurements.
10. The method of clause 8, where prioritizing the one or more positioning measurements and the one or more RF sensing measurements includes prioritizing, based on a size of positioning measurements and a size of RF sensing measurements, one of:
positioning measurements over RF sensing measurements; or
RF sensing measurements over positioning measurements.
11. The method of clause 8, where prioritizing the one or more positioning measurements and the one or more RF sensing measurements is based on one or more priority rules indicated by a location server in the cellular network.
12. The method of clause 8, where prioritizing the one or more positioning measurements and the one or more RF sensing measurements includes prioritizing the one or more positioning measurements over the one or more RF sensing measurements by default.
13. The method of clause 8, where prioritizing the one or more positioning measurements and the one or more RF sensing measurements includes prioritizing positioning measurements and RF sensing measurements associated with a serving cell and one or more neighboring cells over positioning measurements and RF sensing measurements not associated with the serving cell and the one or more neighboring cells.
14. The method of clause 8, further including:
calculating a measurement quality for each of the one or more RF sensing measurements; and
excluding at least one RF sensing measurement from the one or more measurement reports based on the associated measurement quality.
15. The method of clause 8, further including:
excluding at least one RF sensing measurement from the one or more measurement reports; and
indicating that at least one RF sensing measurement is excluded from the one or more measurement reports.
16. The method of clause 1, where generating the one or more measurement reports includes:
including the one or more positioning measurements in one or more positioning measurement reports; and
including the one or more RF sensing measurements in one or more RF sensing measurement reports.
17. The method of clause 16, where each of the one or more RF sensing measurement reports is associated with a unique object in the environment of the device.
18. The method of clause 17, where calculating the one or more RF sensing measurements includes calculating one or more RF sensing measurements associated with an object in the environment of the device, where the one or more RF sensing measurements includes one or more of:
a range of the object from the device;
a doppler measurement associated with movement between the device and the object;
an angle of the RS between the device and the object; or a micro-doppler measurement associated with the object.
19. The method of clause 18, where the one or more RF sensing measurements also includes one or more of:
a class of the object;
a size of the object;
a surface material of the object; or
a radar cross section (RCS) of the object.
20. The method of clause 16, where each of the one or more RF sensing measurement reports is associated with a unique channel estimation based on reception of at least a portion of the one or more RSs by the device.
21. The method of clause 20, where:
receiving the one or more RSs includes receiving the one or more RSs on one or more channels;
calculating the one or more RF sensing measurements includes calculating a channel impulse response (CIR) measurement for each of the one or more channels; and
the one or more RF sensing measurement reports include the CIR measurement for the one or more channels.
22. The method of clause 21, where:
calculating the one or more RF sensing measurements includes calculating the CIR measurement for a channel for each of a plurality of time windows; and
the one or more RF sensing measurement reports excludes one or more CIR measurements associated with one or more time windows of the plurality of time windows.
23. The method of clause 21, where calculating the one or more RF sensing measurements includes:
calculating the CIR measurement for a channel for a first subset of a plurality of time windows; and
preventing calculating the CIR measurement for the channel for a second subset of the plurality of time windows.
24. The method of clause 16, further including prioritizing the one or more positioning measurement reports and the one or more RF sensing measurement reports for providing to the other device.
25. The method of clause 24, where prioritizing the one or more positioning measurement reports and the one or more RF sensing measurement reports includes prioritizing, based on a latency requirement, one of:
positioning measurement reports over RF sensing measurement reports; or
RF sensing measurement reports over positioning measurement reports.
26. The method of clause 24, where prioritizing the one or more positioning measurement reports and the one or more RF sensing measurement reports includes prioritizing, based on a size of positioning measurement reports and a size of RF sensing measurement reports, one of:
positioning measurements over RF sensing measurements; or
RF sensing measurements over positioning measurements.
27. The method of clause 24, where prioritizing the one or more positioning measurement reports and the one or more RF sensing measurement reports is based on one or more priority rules indicated by a location server in the cellular network.
28. The method of clause 24, where prioritizing the one or more positioning measurement reports and the one or more RF sensing measurement reports includes prioritizing the one or more positioning measurement reports over the one or more RF sensing measurement reports by default.
29. The method of clause 24, where prioritizing the one or more positioning measurement reports and the one or more RF sensing measurement reports includes prioritizing positioning measurement reports and RF sensing measurement reports associated with a serving cell and one or more neighboring cells over positioning measurement reports and RF sensing measurement reports not associated with the serving cell and the one or more neighboring cells.
30. The method of clause 24, further including:
calculating a measurement quality for each of the one or more RF sensing measurements; and
excluding at least one RF sensing measurement from the one or more RF sensing measurement reports based on the associated measurement quality.
31. The method of clause 24, further including:
excluding at least one RF sensing measurement report from being reported; and
indicating that the at least one RF sensing measurement report is excluded from being reported.
32. A device for performing radio frequency (RF) sensing in a cellular network, the device including:
a wireless transceiver;
a memory; and
at least one processor coupled to the wireless transceiver and the memory, where the at least one processor is configured to:
receive, via the wireless transceiver, one or more reference signals (RSs), where receiving one or more RSs includes receiving an RS on one or more paths associated with the device;
calculate one or more positioning measurements from the one or more RSs;
calculate one or more RF sensing measurements from the one or more RSs;
generate one or more measurement reports, where the one or more measurement reports include at least a portion of the one or more positioning measurements and the one or more RF sensing measurements; and
provide at least a portion of the one or more measurement reports to another device in the cellular network, where measurements included in the one or more measurement reports are to be used for positioning of a user equipment (UE) in the cellular network and for RF sensing associated with the device.
33. The device of clause 32, where calculating the one or more positioning measurements includes one or more of:
calculating a per path RS receive power (RSRP) from the RS received on each path, where the one or more RF sensing measurements may also include the per path RSRP; or
calculating a per path phase from the RS received on each path, where the one or more RF sensing measurements may also include the per path phase.
34. The device of clause 32, where calculating the one or more RF sensing measurements includes calculating a per path Doppler measurement from the RS received on each path.
35. The device of clause 34, where calculating the one or more RF sensing measurements also includes calculating a per path angle estimation for the RS received on each path.
36. The device of clause 32, where calculating the one or more RF sensing measurements includes generating, for at least one other RF sensing measurement, one or more of:
a measurement quality of the RF sensing measurement; or
a time stamp associated with the RF sensing measurement.
37. The device of clause 32, where generating the one or more measurement reports includes including at least one of the one or more positioning measurements and at least one of the one or more RF sensing measurements in a first measurement report.
38. The device of clause 37, where providing the at least portion of the one or more measurement reports to another device includes providing the first measurement report in an NR-Multi-RTT-AdditionalMeasurementElement information element (IE).
39. The device of clause 37, where the at least one processor is further configured to prioritize the one or more positioning measurements and the one or more RF sensing measurements for inclusion in the one or more measurement reports.
40. The device of clause 39, where prioritizing the one or more positioning measurements and the one or more RF sensing measurements includes prioritizing, based on a latency requirement, one of:
positioning measurements over RF sensing measurements; or
RF sensing measurements over positioning measurements.
41. The device of clause 39, where prioritizing the one or more positioning measurements and the one or more RF sensing measurements includes prioritizing, based on a size of positioning measurements and a size of RF sensing measurements, one of:
positioning measurements over RF sensing measurements; or
RF sensing measurements over positioning measurements.
42. The device of clause 39, where prioritizing the one or more positioning measurements and the one or more RF sensing measurements is based on one or more priority rules indicated by a location server in the cellular network.
43. The device of clause 39, where prioritizing the one or more positioning measurements and the one or more RF sensing measurements includes prioritizing the one or more positioning measurements over the one or more RF sensing measurements by default.
44. The device of clause 39, where prioritizing the one or more positioning measurements and the one or more RF sensing measurements includes prioritizing positioning measurements and RF sensing measurements associated with a serving cell and one or more neighboring cells over positioning measurements and RF sensing measurements not associated with the serving cell and the one or more neighboring cells.
45. The device of clause 39, where the at least one processor is further configured to:
calculate a measurement quality for each of the one or more RF sensing measurements; and
exclude at least one RF sensing measurement from the one or more measurement reports based on the associated measurement quality.
46. The device of clause 39, where the at least one processor is further configured to:
exclude at least one RF sensing measurement from the one or more measurement reports; and
indicate that at least one RF sensing measurement is excluded from the one or more measurement reports.
47. The device of clause 32, where generating the one or more measurement reports includes:
including the one or more positioning measurements in one or more positioning measurement reports; and
including the one or more RF sensing measurements in one or more RF sensing measurement reports.
48. The device of clause 47, where each of the one or more RF sensing measurement reports is associated with a unique object in the environment of the device.
49. The device of clause 48, where calculating the one or more RF sensing measurements includes calculating one or more RF sensing measurements associated with an object in the environment of the device, where the one or more RF sensing measurements includes one or more of:
a range of the object from the device;
a doppler measurement associated with movement between the device and the object;
an angle of the RS between the device and the object; or a micro-doppler measurement associated with the object.
50. The device of clause 49, where the one or more RF sensing measurements also includes one or more of:
a class of the object;
a size of the object;
a surface material of the object; or
a radar cross section (RCS) of the object.
51. The device of clause 47, where each of the one or more RF sensing measurement reports is associated with a unique channel estimation based on reception of at least a portion of the one or more RSs by the device.
52. The device of clause 51, where:
receiving the one or more RSs includes receiving the one or more RSs on one or more channels;
calculating the one or more RF sensing measurements includes calculating a channel impulse response (CIR) measurement for each of the one or more channels; and
the one or more RF sensing measurement reports include the CIR measurement for the one or more channels.
53. The device of clause 52, where:
calculating the one or more RF sensing measurements includes calculating the CIR measurement for a channel for each of a plurality of time windows; and
the one or more RF sensing measurement reports excludes one or more CIR measurements associated with one or more time windows of the plurality of time windows.
54. The device of clause 52, where calculating the one or more RF sensing measurements includes:
calculating the CIR measurement for a channel for a first subset of a plurality of time windows; and
preventing calculating the CIR measurement for the channel for a second subset of the plurality of time windows.
55. The device of clause 47, where the at least one processor is further configured to prioritize the one or more positioning measurement reports and the one or more RF sensing measurement reports for providing to the other device.
56. The device of clause 55, where prioritizing the one or more positioning measurement reports and the one or more RF sensing measurement reports includes prioritizing, based on a latency requirement, one of:
positioning measurement reports over RF sensing measurement reports; or
RF sensing measurement reports over positioning measurement reports.
57. The device of clause 55, where prioritizing the one or more positioning measurement reports and the one or more RF sensing measurement reports includes prioritizing, based on a size of positioning measurement reports and a size of RF sensing measurement reports, one of:
positioning measurements over RF sensing measurements; or RF sensing measurements over positioning measurements.
58. The device of clause 55, where prioritizing the one or more positioning measurement reports and the one or more RF sensing measurement reports is based on one or more priority rules indicated by a location server in the cellular network.
59. The device of clause 55, where prioritizing the one or more positioning measurement reports and the one or more RF sensing measurement reports includes prioritizing the one or more positioning measurement reports over the one or more RF sensing measurement reports by default.
60. The device of clause 55, where prioritizing the one or more positioning measurement reports and the one or more RF sensing measurement reports includes prioritizing positioning measurement reports and RF sensing measurement reports associated with a serving cell and one or more neighboring cells over positioning measurement reports and RF sensing measurement reports not associated with the serving cell and the one or more neighboring cells.
61. The device of clause 55, where the at least one processor is further configured to:
calculate a measurement quality for each of the one or more RF sensing measurements; and
exclude at least one RF sensing measurement from the one or more RF sensing measurement reports based on the associated measurement quality.
62. The device of clause 55, where the at least one processor is further configured to:
exclude at least one RF sensing measurement report from being reported; and
indicate that the at least one RF sensing measurement report is excluded from being reported.

Therefore, it is intended that claimed subject matter not be limited to the particular examples disclosed, but that such claimed subject matter may also include all aspects falling within the scope of appended claims, and equivalents thereof.

1. A method performed by a device for performing radio frequency (RF) sensing in a cellular network, the method comprising:
receiving one or more reference signals (RSs), wherein receiving one or more RSs includes receiving an RS on one or more paths associated with the device;
calculating one or more positioning measurements from the one or more RSs;
calculating one or more RF sensing measurements from the one or more RSs;
generating one or more measurement reports, wherein the one or more measurement reports include at least a portion of the one or more positioning measurements and the one or more RF sensing measurements; and
providing at least a portion of the one or more measurement reports to another device in the cellular network, wherein measurements included in the one or more measurement reports are to be used for positioning of a user equipment (UE) in the cellular network and for RF sensing associated with the device.

2. The method of claim 1, wherein calculating the one or more positioning measurements includes one or more of:
calculating a per path RS receive power (RSRP) from the RS received on each path, wherein the one or more RF sensing measurements may also include the per path RSRP; or
calculating a per path phase from the RS received on each path, wherein the one or more RF sensing measurements may also include the per path phase.

3. The method of claim 1, wherein calculating the one or more RF sensing measurements includes calculating a per path Doppler measurement from the RS received on each path.

4. (canceled)

5. The method of claim 1, wherein calculating the one or more RF sensing measurements includes generating, for at least one other RF sensing measurement, one or more of:
a measurement quality of the RF sensing measurement; or
a time stamp associated with the RF sensing measurement.

6. The method of claim 1, wherein generating the one or more measurement reports includes including at least one of the one or more positioning measurements and at least one of the one or more RF sensing measurements in a first measurement report.

7. (canceled)

8. The method of claim 6, further comprising prioritizing the one or more positioning measurements and the one or more RF sensing measurements for inclusion in the one or more measurement reports.

9. (canceled)

10. (canceled)

11. The method of claim 8, wherein prioritizing the one or more positioning measurements and the one or more RF sensing measurements is based on one or more priority rules indicated by a location server in the cellular network.

12. The method of claim 8, wherein prioritizing the one or more positioning measurements and the one or more RF sensing measurements includes prioritizing the one or more positioning measurements over the one or more RF sensing measurements by default.

13. The method of claim 8, wherein prioritizing the one or more positioning measurements and the one or more RF sensing measurements includes prioritizing positioning measurements and RF sensing measurements associated with a serving cell and one or more neighboring cells over positioning measurements and RF sensing measurements not associated with the serving cell and the one or more neighboring cells.

14. (canceled)

15. (canceled)

16. The method of claim 1, wherein generating the one or more measurement reports includes:
including the one or more positioning measurements in one or more positioning measurement reports; and
including the one or more RF sensing measurements in one or more RF sensing measurement reports.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A device for performing radio frequency (RF) sensing in a cellular network, the device comprising:
a wireless transceiver;
a memory; and
at least one processor coupled to the wireless transceiver and the memory, wherein the at least one processor is configured to:
receive, via the wireless transceiver, one or more reference signals (RSs), wherein receiving one or more RSs includes receiving an RS on one or more paths associated with the device;
calculate one or more positioning measurements from the one or more RSs;
calculate one or more RF sensing measurements from the one or more RSs;
generate one or more measurement reports, wherein the one or more measurement reports include at least a portion of the one or more positioning measurements and the one or more RF sensing measurements; and
provide at least a portion of the one or more measurement reports to another device in the cellular network, wherein measurements included in the one or more measurement reports are to be used for positioning of a user equipment (UE) in the cellular network and for RF sensing associated with the device.

33. The device of claim 32, wherein calculating the one or more positioning measurements includes one or more of:
calculating a per path RS receive power (RSRP) from the RS received on each path, wherein the one or more RF sensing measurements may also include the per path RSRP; or
calculating a per path phase from the RS received on each path, wherein the one or more RF sensing measurements may also include the per path phase.

34. The device of claim 32, wherein calculating the one or more RF sensing measurements includes calculating a per path Doppler measurement from the RS received on each path.

35. The device of claim 34, wherein calculating the one or more RF sensing measurements also includes calculating a per path angle estimation for the RS received on each path.

36. The device of claim 32, wherein calculating the one or more RF sensing measurements includes generating, for at least one other RF sensing measurement, one or more of:
a measurement quality of the RF sensing measurement; or
a time stamp associated with the RF sensing measurement.

37. The device of claim 32, wherein generating the one or more measurement reports includes including at least one of the one or more positioning measurements and at least one of the one or more RF sensing measurements in a first measurement report.

38. (canceled)

39. The device of claim 37, wherein the at least one processor is further configured to prioritize the one or more positioning measurements and the one or more RF sensing measurements for inclusion in the one or more measurement reports.

40. (canceled)

41. (canceled)

42. The device of claim 39, wherein prioritizing the one or more positioning measurements and the one or more RF sensing measurements is based on one or more priority rules indicated by a location server in the cellular network.

43. The device of claim 39, wherein prioritizing the one or more positioning measurements and the one or more RF sensing measurements includes prioritizing the one or more positioning measurements over the one or more RF sensing measurements by default.

44. The device of claim 39, wherein prioritizing the one or more positioning measurements and the one or more RF sensing measurements includes prioritizing positioning measurements and RF sensing measurements associated with a serving cell and one or more neighboring cells over positioning measurements and RF sensing measurements not associated with the serving cell and the one or more neighboring cells.

45. (canceled)

46. The device of claim 39, wherein the at least one processor is further configured to:
exclude at least one RF sensing measurement from the one or more measurement reports; and
indicate that at least one RF sensing measurement is excluded from the one or more measurement reports.

47. The device of claim 32, wherein generating the one or more measurement reports includes:
including the one or more positioning measurements in one or more positioning measurement reports; and
including the one or more RF sensing measurements in one or more RF sensing measurement reports.

48. The device of claim 47, wherein each of the one or more RF sensing measurement reports is associated with a unique object in the environment of the device.

49. The device of claim 48, wherein calculating the one or more RF sensing measurements includes calculating one or more RF sensing measurements associated with an object in the environment of the device, wherein the one or more RF sensing measurements includes one or more of:
a range of the object from the device;
a doppler measurement associated with movement between the device and the object;
an angle of the RS between the device and the object; or
a micro-doppler measurement associated with the object.

50. The device of claim 49, wherein the one or more RF sensing measurements also includes one or more of:
a class of the object;
a size of the object;
a surface material of the object; or
a radar cross section (RCS) of the object.

51. The device of claim 47, wherein each of the one or more RF sensing measurement reports is associated with a unique channel estimation based on reception of at least a portion of the one or more RSs by the device.

52. The device of claim 51, wherein:
receiving the one or more RSs includes receiving the one or more RSs on one or more channels;
calculating the one or more RF sensing measurements includes calculating a channel impulse response (CIR) measurement for each of the one or more channels; and
the one or more RF sensing measurement reports include the CIR measurement for the one or more channels.

53. The device of claim 52, wherein:
calculating the one or more RF sensing measurements includes calculating the CIR measurement for a channel for each of a plurality of time windows; and
the one or more RF sensing measurement reports excludes one or more CIR measurements associated with one or more time windows of the plurality of time windows.

54. The device of claim 52, wherein calculating the one or more RF sensing measurements includes:
calculating the CIR measurement for a channel for a first subset of a plurality of time windows; and
preventing calculating the CIR measurement for the channel for a second subset of the plurality of time windows.

55. The device of claim 47, wherein the at least one processor is further configured to prioritize the one or more positioning measurement reports and the one or more RF sensing measurement reports for providing to the other device.

56. (canceled)

57. (canceled)

58. (canceled)

59. (canceled)

60. (canceled)

61. (canceled)

62. (canceled)
